(19) United States
(12) Patent Application Publication
(10) Pub. No.: US 2026/0319107 A1
(43) Pub. Date: Oct. 15, 2026

(54) RADIATION-POWERED HIGH DOSE RATE, AND HIGH DOSE RADIATION SENSOR AND SYSTEM

(71) Applicant: Gold Standard Radiation Detection, Inc., Albuquerque, NM (US)

(72) Inventors: Mark DERZON, Albuquerque, NM (US); Paul REYNOLDS, Albuqeurque, NM (US)

(21) Appl. No.: 19/166,583

(22) PCT Filed: Jan. 15, 2025
(86) PCT No.: PCT/US2025/011747

§ 371 Date: Sep. 18, 2025

Related U.S. Application Data
(60) Provisional application No. 63/618,296, filed on Jan. 6, 2024.

(51) Int. Cl. G01T 1/02

(52) U.S. Cl. CPC G01T 1/02

(57) ABSTRACT

In one or more amendments, an apparatus has a particle source and a thermopile. The particle source is configured to send particles to the thermopile. The thermopile is configured to measure a location, a spatial characteristic and a radiation rate of ions received from the particle source to produce a measurement value. In response to the measurement value, the particle source is configured to send control additional radiation to the thermopile and target.

### CROSS REFERENCE TO RELATED PATENT APPLICATION

This patent application claims priority to U.S. Provisional Patent Application Ser. No. 63/618,296, filed on Jan. 6, 2024 and titled “Radiation-Powered High Dose Rate, and High Dose Radiation Sensor and System,” which is incorporated by reference herein.

This patent application mentions and incorporates by reference the following patent applications. U.S. Patent Application Publication Number 2024/0103190, published on Mar. 28, 2024 and titled “Time-resolved Radiation Dose and Health Mapping in Extreme Environments” is incorporated by reference herein. U.S. Patent Application Publication Number 2023/0260737, published on Aug. 17, 2023 and titled “Long Life-Time, Short Pulse, High Current Ion Source and Particle Accelerator” is incorporated by reference herein.

### FIELD

The disclosure relates generally to radiation sensors, and specifically to radiation sensors that measure radiation dose and dose rate.

### BACKGROUND

Radiation is typically measured indirectly, with radiation dose being a common reference for biological damage assessment. It is usually inferred from other measurements or processed data. Radiation dose is typically defined as energy deposited per unit mass (ergs per gram).

Known sensors can use large bulk sensors such as scintillators or semiconductors, or other methods to infer radiation dose (measured in units of ergs/g) from, for example, a flux, photon emission, or charge associated with ionizing particle interactions. The basic cross sections or interaction probabilities of the ionizing particles are rarely known to uncertainties less than 5%. Therefore, uncertainties in the radiation dose or energy deposition inferred from measurements that involve many of these interactions are typically 5 percent or greater. In addition to providing indirect measurement of dose and dose rate, known radiation sensors typically require power during the sensing process. For example, a voltage bias induced by a power source can sweep a charge to a phototube or across a semiconductor. Additionally, calibration and reproducibility of known sensors can be problematic. Typically, calibrating known sensors is complex, particularly for the low temperature changes expected with penetrating radiation as the means of measuring dose. Complex analog and digital circuitry are often required to obtain full time-dependent measurements of the integral dose. Lastly, all radiation sensors can have limited dynamic ranges. Typically, these ranges vary over intensity ranges of 2 to 3 orders of magnitude (100-1000 times). Most known scintillators and charge particles detectors can also have multiple timescales associated with their response to the ionizing radiation. These artifacts can affect interpretation of time dependent signals.

Penetrating and ionizing radiation sensors are commonly scintillation based (light emission), or charge collection based (gas detectors such as, for example, the Geiger Mueller tubes, proportional counters, or semiconductors). Both classes of sensors are relatively sensitive and require active electronics to power the transducer element (for example a phototube).

Pyroelectric or thermocouple sensors can measure infrared (IR) or thermal forms of radiation. Thermal sensors with high sensitivity such as thermistors or resistive temperature sensors can have some sort of imposed bias necessitating a power source that is always on even when there is no appreciable radiation. This means an electric field source is applied and the change in resistance is measured electronically.

Optically Stimulated Luminescence (OSL) and Thermo-Luminescent Detectors (TLDs) are a class of known inherently integrating radiation sensors. In these, the light emitted after heating is directly proportional to the dose captured. Integrating radiation sensors are not typically considered time-resolved or dose rate measuring sensors. Rather, integrating radiation sensors capture light through a secondary photo sensor or secondary transducer. The secondary sensor typically requires a stage of calibration like the other mentioned radiation sensors-complicating calibration. Neither the OSL nor the TLD is considered time resolved. They provide integrated dose measurements and can be employed in high-radiation environments. Both, however, also have uncertainties that can be determined through a chain of cross-sections, temperature, and handling issues.

Known scintillators, calorimeters and semiconductor devices belong to the class of active radiation dose sensors. They use power to read the signals caused by ionizing radiation. Generally, the byproduct measured are the electron or ion trails caused after an interaction. Either a bias is applied to collect charge carriers or a photosensor is used to count photons that are generated and transported to the photosensor. In each case, the measurement is not a direct measurement of dose. It is a measurement of the number of interactions and likely the amount of ions, electrons, or photons generated. The signal is then converted into dose via processing of known cross sections. Because the measurement uses other known quantities, these are not direct measurements of dose, and the errors can be large. These systems can be made at large scale and can be very sensitive. Typically, uncertainties or accuracy and/or precision with these instruments is limited by knowledge of the cross sections or interaction probability.

Calorimeters are typically cryogenically cooled and sensitive to minute temperature changes associated with individual radiation interactions. Among their other characteristics, calorimeters typically offer exquisite energy resolution, they are generally large enough for the radiation of interest to deposit all their energy into an active volume, and they are very slow. They also require a separate transducer and independent power.

Thermocouples are a different class of device than OSL/TLDs in that they can integrate the dose but they do not store the signature. Calorimeters, semiconductors and scintillators also do not maintain the signature. Thermocouples, however, are a time-resolving sensor with extremely fast response. Therefore, if background thermal variations can be subtracted, thermocouples can measure the dose by integrating the measurement. Known thermopiles are typically used in applications involving infrared, visible, some ultraviolet radiation but not for those involving penetrating and ionizing radiation. An inventor is aware of unpublished work where a single thermocouple has been used in a laboratory to measure as good as 50 ps timing resolution. No spatial or energy resolved information was obtainable in that work.

A need exists for radiation dose sensors that can achieve uncertainties less than 5%. In the medical field, for example, a low dose uncertainty can mean the difference between life and death. The Int. Journal of Radiation Oncology, Jul. 15, 1995, Volume 32, Issue 4, Pages 1227-1237 emphasizes the importance of being within 1% uncertainty. FIG. 1 offers simplified regime of conditions where radiation sensors are useful in order to set rough scale.

Thus, a need exists for an improved radiation dose sensor with high dynamic range, independent of external power sources, that can measure radiation dose to less than 5% uncertainty.

### SUMMARY

In one or more embodiments, an apparatus has a particle source and a thermopile. The particle source is configured to send a first plurality of radiation particles to the thermopile. The thermopile is configured to measure a location, a spatial characteristic and a radiation rate of the first plurality of particles received from the particle source to produce a measurement value. In response to the measurement value, the particle source is configured to send a second plurality of particles to the thermopile.

In some embodiments, a method can include determining a desired integrated radiation dose value to be delivered to a target and determining a desired error value associated with the desired integrated radiation dose value. The desired error value has a threshold. The method can further include sending from an ion source and to the target a first pulsed radiation and, in response to the first plurality of pulsed radiation impacting the target, measuring, using a detector, a temperature value associated with an integrated radiation dose value delivered to the target. The method can further include calculating an error value between the integrated radiation dose value delivered to the target and the desired integrated radiation dose value and, in response to the error value not satisfying the threshold of the desired error value, sending from the ion source and to the target a second plurality pulsed radiation.

### BRIEF DESCRIPTION OF THE DRAWINGS

FIG. 1 shows an illustration of physical parameters of thermopiles, according to an embodiment.

FIG. 2 shows a table with a variety of Seebeck coefficients found in thermocouples, according to an embodiment.

FIG. 3A shows an illustration of the Seebeck effect in a time domain context of an X-ray machine or a nuclear event, according to an embodiment.

FIG. 3B shows an estimate of a voltage amplitude, according to an embodiment.

FIG. 4A shows an illustration of a basic multi-junction thermopile concept, according to an embodiment.

FIG. 4B shows an illustration of a thermopile radiation sensor for a thermopile fabricated using lithographic processes on a surface, according to an embodiment.

FIG. 4C shows a flat embodiment for a thermopile with a massive array of thermocouples, according to an embodiment.

FIG. 5 shows an illustration of a schematic for example thermopile configurations constructed in a through-hole via configuration, according to an embodiment.

FIGS. 6A and 6B show an illustration of a schematic of an example surface patterned array of thermocouple junctions with cold junctions disposed about a center, according to an embodiment.

FIG. 7 shows a representation of a schematic for a passive element thermopile for compact measurement of penetrating radiation dose using a through-hole, according to an embodiment.

FIG. 8 shows a schematic for thermopile layouts configured in a ring, according to an embodiment.

FIG. 9 shows an illustration of an example schematic for a ring to monitor dose at a practitioner's hand during fluoroscopy, according to an embodiment.

FIG. 10A shows a schematic view of a thermopile, according to an embodiment.

FIG. 10B shows a perspective view of a keyed shield, according to an embodiment.

FIG. 11 shows an expanded front view of a thermopile, according to an embodiment.

FIG. 12 shows an example pulse train diagram, an example pulse train plot and an example dose plot to convey an example accuracy of pulse-based particle beam sources in achieving a desired dose.

FIG. 13 shows a representation of a four-channel spectrometer, according to an embodiment.

FIG. 14 shows a perspective view of a thermopile and a keyed shield, according to an embodiment.

FIG. 15 shows a representative of a system including particle beam sources and sensor(s) for tomography, according to an embodiment.

FIG. 16 shows a block diagram of a system including a compute device, a particle beam source, an aperture, a target, and a sensor/detector, according to an embodiment.

FIG. 17 shows a block diagram of an algorithm to reach a desired integrated radiation dose having higher accuracies than known algorithms, according to an embodiment.

FIG. 18 shows a plot indicating a greater than order of magnitude improvement in signal-to-noise ratio of a radiation dose sensor, according to an embodiment.

FIG. 19 shows a flowchart of a temperature correction method and a system block diagram of a system that can implement the method, according to an embodiment.

FIG. 20 shows a plot of sensor data, according to an embodiment.

FIG. 21 shows a block diagram of a system for processing sensor data, according to an embodiment.

FIG. 22 shows an example illustration of a system implementation, according to an embodiment.

FIG. 23 shows a block diagram for a method to reduce noise and correct temperature and time-dependence of a sensor and a method for calibrating a sensor, according to embodiments.

### DETAILED DESCRIPTION

One or more embodiments include an improved thermopile for the application of penetrating radiation according to the definition of radiation in terms of energy deposition (e.g. ergs/g), and it is employed in situations where environment temperatures changes are small or can be corrected for. For example, applications can include measurements at short timescales or using externally cooled systems. Dynamic range, background correction, and enhanced signal-to-noise can be obtained by the use of spacing the hot and cold junctions and shielding configured to differentiate signal and separate signal from background or scattered radiation. Cooling and temperature control of the environment can also enhance signal-to-noise.

The improved thermopile can provide practical time-resolved measurements that can be as accurate as standard thermocouples (a very accurate easy to calibrate instrument with NIST traceable provenance) with minimal cross calibration in a fast-time resolved sensor. The improved thermopile can be configured for simple dosimetry, imaging dosimetry, as a spectrometer or with time-, space, and energy resolution at once depending on the need and application. Systems incorporating the improved thermopile can be used to replace certain fast framing systems, scintillators, semiconductors currently in use as well as TLD/OSLs in certain environments. Cooled variants and massively parallel, and/or layered embodiments will rival the other technologies with simpler and more accurate radiation-field measurements.

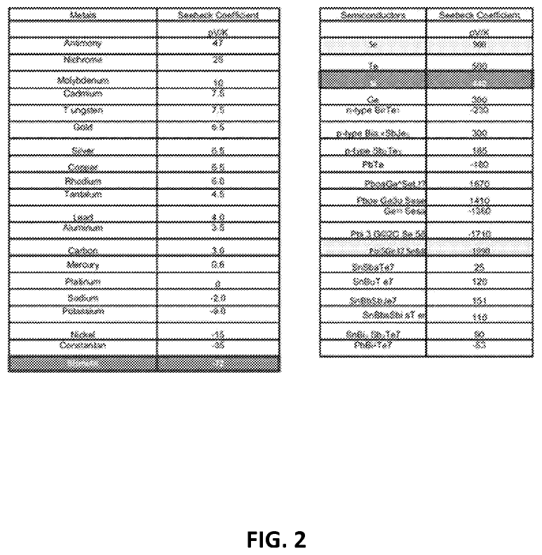

Embodiments provide an apparatus for the measurement of radiation, comprising: (a) a first plurality of elements comprising a first material; (b) a second plurality of elements comprising a second material; (c) wherein the first plurality of elements and second plurality of elements are configured to form a third plurality of junctions and fourth plurality of junctions, connected in series comprising alternating junctions from the third and fourth plurality of junctions; with the first junction in the series in electrical communication with a first electrode, and the last junction in the series in electrical communication with a second electrode; and (d) wherein junctions in the third plurality have a different thermal response to incident radiation that junctions in the fourth plurality. Some embodiments further comprise an amplifier connected to the first and second electrodes. FIG. 2 provides a partial list of the types of material junctions embodiments can make use of but is not limited to those in the table.

Some embodiments comprise a radiation shield that provides greater radiation shielding of junctions in the third plurality than junctions in the fourth plurality. Some embodiments comprise a heat dissipation element in thermal communication with junctions in the third plurality. Some embodiments comprise thermal insulation disposed between junctions in the third plurality and junctions in the fourth plurality. Some embodiments involve a physical separation of the cold and hot junctions alone. One example of this is when measuring from a point source. If the hot junction is near to the source and the cold junction (perhaps 10 times the distance away, the distance squared scaling means that the radiation dose at the hot junction would be nominally 1% of that at the nearer cold junction.

In some embodiments, junctions in the third plurality have different thermal properties than junctions in the fourth plurality. Some embodiments comprise thermal insulation disposed between junctions in the fourth plurality and ambient conditions. In some embodiments the first material and the second material provide a Seebeck effect when placed in contact with each other.

Some embodiments comprise a thermally insulating substrate, wherein junctions in the third plurality are disposed on a first surface of the substrate, and junctions in the fourth plurality are disposed on a second surface, opposite the first surface of the substrate.

In some embodiments, junctions in the fourth plurality are in a vacuum. In some embodiments the heat dissipation element comprises a cold plate. In some embodiments the heat dissipation element comprises a heat sink. In some embodiments junctions in the third plurality have lower heat capacity than junctions in the fourth plurality. In some embodiments, junctions in the third plurality are smaller than junctions in the fourth plurality.

In some embodiments the junctions are mounted with a substrate, and wherein junctions in the third plurality are disposed in a first region of the substrate, and junctions in the fourth plurality are disposed in a second region of the substrate, wherein the first region is distinct from the second region. In some embodiments the junctions are disposed in a multi-dimensional array.

The total number of junctions varies from 1 to over 10,000. In this example, 4-orders of magnitude can be provide using the array of thermocouples. Inherently a single thermocouple is useful to 2-3 orders of magnitude. Using the multiplicity of junctions these devices and using newer electronics these devices can easily cover dynamic ranges of 2-10 orders of magnitude. This far exceeds many competing technologies. They can be useful in time ranges of picoseconds (ps) to milliseconds depending on their structure and environmental temperature compensation.

While scintillators and charge collectors have non-linear time dependent features, thermocouples do not. A single thermocouple measurement to 50 ps FWHM can be achieved, which is much longer than the time for a phonon to travel across a junction. Therefore, there is no reason to expect non-linearities to that timescale in a thermocouple or thermopile. The factor that will most affect timing to that limit is expected to be the electronic ringing from a large-scale array.

One or more embodiments include radiation shielding so that the devices can be widely applicable, whereas known commercial thermocouples and thermopiles used for non-penetrating radiation typically are not

Thermopiles can be unpowered in the sense that no external power is supplied to provide the signal. As radiation heats the junctions differentially (i.e., meaning that one junction is colder than the other junction), their basic characteristics give rise to a voltage which is related to the temperature difference and that difference is determined by the materials.

Thermopiles are inherently hard to radiation, particularly photons, as they don't get damaged by the temperature changes or have particles moved and disarranged (as happens with neutron or heavy particle (for example a proton) damage). When compared to semiconductors or scintillators where the chemistry is more complex, thermopiles take more radiation before changing their properties.

In some embodiments the first material is chosen from the group consisting of bismuth, selenium, silicon, and Pbi5Ge37 (see FIG. 2). In some embodiments the second material is chosen from the group consisting of bismuth, selenium, silicon, and Pbi5Ge37, excluding the first material.

The unpowered devices described herein, also described as thermopile devices, exhibit very high dynamic range, have fast time response, are small, and achieve higher accuracies in dose measurement than known sensors. The thermopile devices typically are not sensitive to very low dose rates that are comparable in value to background radiation. Known, large detectors can have orders of magnitude more sensitivity. For many uses, however, the thermopile devices can offer significant benefits in accuracy, timing, and dynamic range.

Calorimeters also measure temperature rise like the thermocouple (also called thermopile) array. Calorimeters are very slow but offer extraordinary energy resolution. They are far larger than a thermocouple junction and must capture each event so they only indirectly measure dose. They work by measuring the temperature rise from individual events using a separate transducer.

One or more embodiments use thermocouple junctions of a thermopile device to rapidly measure a radiation dose. The thermopile can act as a transducer and convert a thermal energy to an integrated radiation dose readout. The thermopile devices can separate the energies by the junctions of the thermocouples, enabling single particle spectroscopy. This is not generally done. If cryogenically cooled and appropriately 3D configured, the thermopile devices can function as a fast version of the calorimeter.

The utility of the junctions as described here is distinctly different than in calorimeters. The junctions are small compared to particle range in the calorimeters the media must be large enough to capture the total energy from individual events.

Multiple embodiments utilize radiation shielding, longer separations between hot and cold junctions and faster timing to discriminate between normal thermal environmental effects and the effects of the penetrating radiation. In this way the one or more embodiments can be configured as very fast in the range of 50 ps to 999 ms penetrating radiation sensors and penetrating radiation spectrometers.

The accompanying drawings form aspects of the specification and practice of potential embodiments. They are meant to illustrate embodiments and serve as examples. They are not meant to limit the disclosure. For example, intermediate sections of third Seebeck materials can be inserted between the hot and cold sides to add additional junctions and clarity in interpretation. This is not shown in the illustrations.

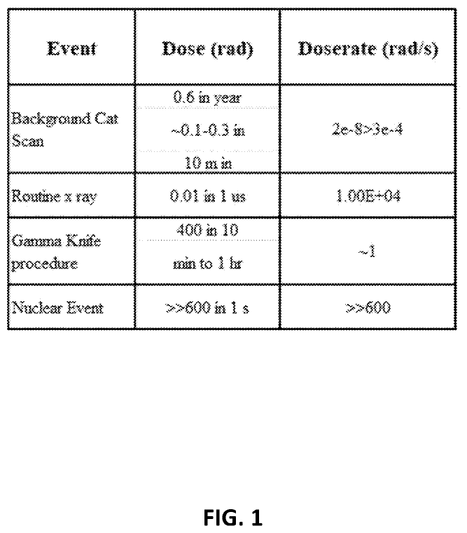

FIG. 1 illustrates some basic physical parameters relevant to the present disclosure. Background due to environmental changes and environmental temperature change is slow, but must be corrected or taken into account.

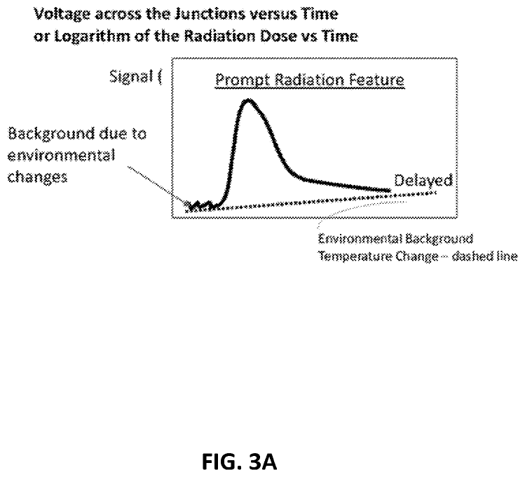

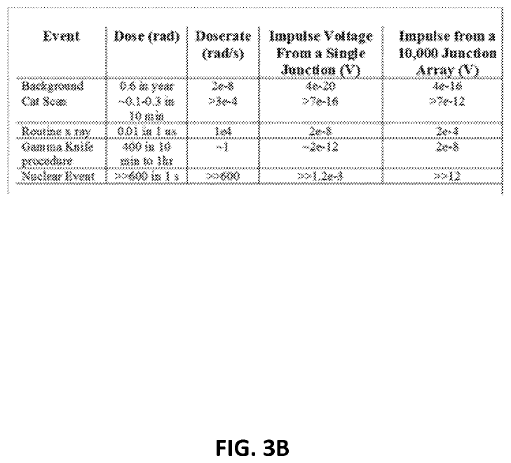

FIG. 2. The table shows a variety of Seebeck coefficients that can be found in thermocouples. FIG. 3A is an illustration of the effect in a time domain context of something like an x ray machine or nuclear event. FIG. 3B estimate of the voltage amplitude under certain conditions. Radiation events of interest compared to the total Dose and Dose Rates as well as measurement ranges for device operation in terms of impulse voltage from a single junction versus a 10,000-junction thermocouple (a multiple junction thermocouple is defined as a thermopile). The background reflects normal environmental changes in the in the junction voltage difference; if the radiation induced changes are greater than the thermal, over the time-period of the measurement, then the measurement is of the radiation effect.

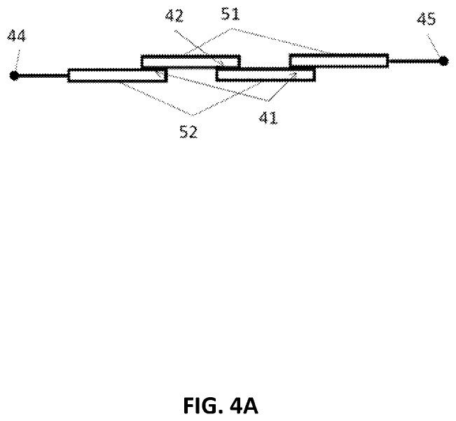

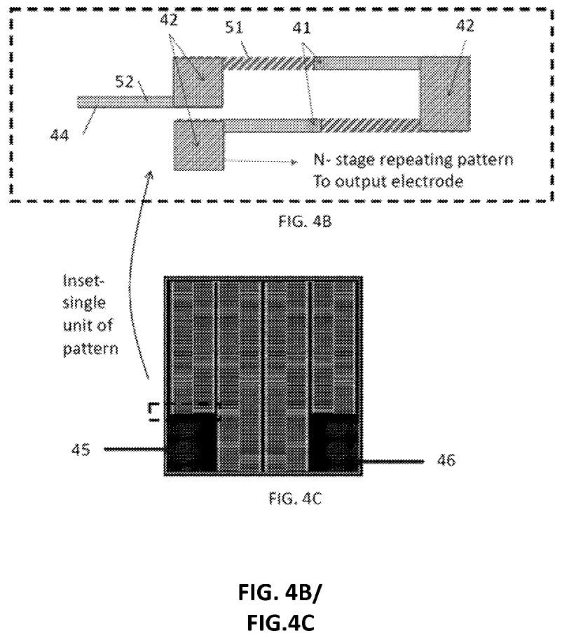

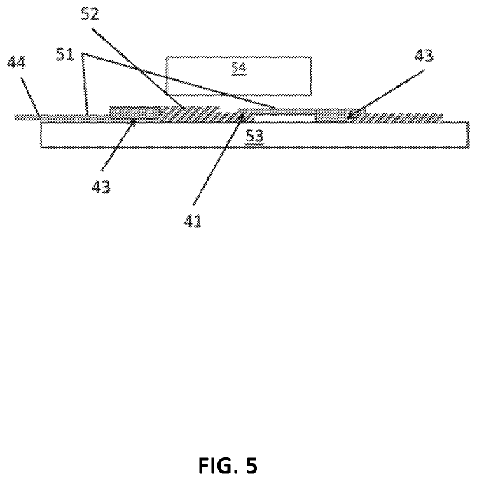

FIG. 4A illustrates a basic multi-junction thermopile concept. FIG. 4B illustrates a configuration for a thermopile radiation sensor based on a design for a thermopile to be fabricated using lithographic processes on a surface. FIG. 4C shows a flat embodiment for a thermopile with 100's of units. It is the separation of junctions—in conjunction with radiation shielding that is the unique feature and makes the devices useful for penetrating radiation.

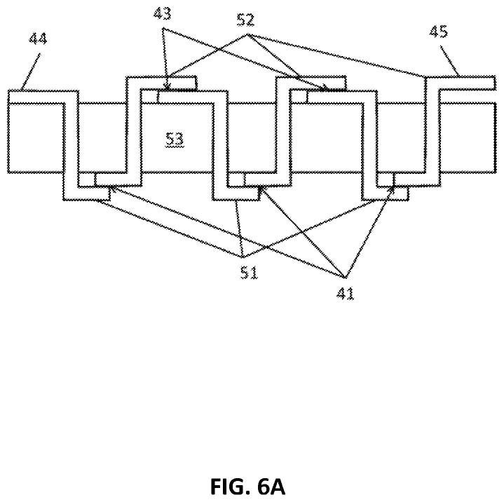

FIG. 5 provides schematic illustrations of example embodiments of pile configurations constructed in a through-hole via configuration. The hot and cold junctions can be separated so that either the penetrating radiation illuminates each junction differently or each junction retains heat differently. These are acceptable for fairly low energy penetrating radiation.

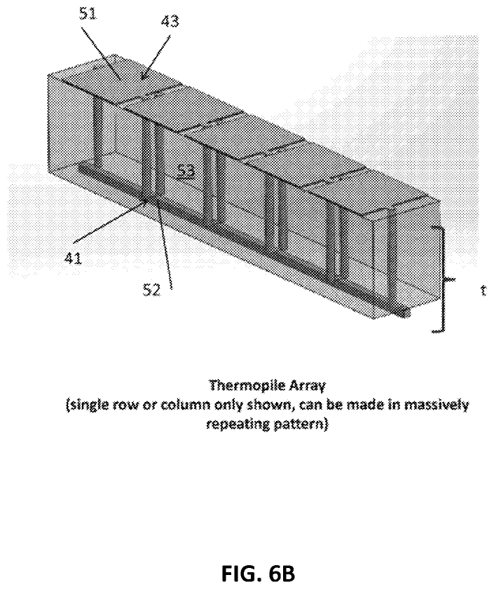

FIG. 6 is a schematic illustration of an example embodiment of a surface patterned array of thermocouple junctions with cold junctions located in the center. The cold junctions are shielded from the radiation with a high Z, high density plate such as tungsten to reduce the dose at the cold junctions enhancing the response from the penetrating radiation over that which can be achieved by material choice and geometry alone. This can also be implemented in the geometry of FIG. 4.

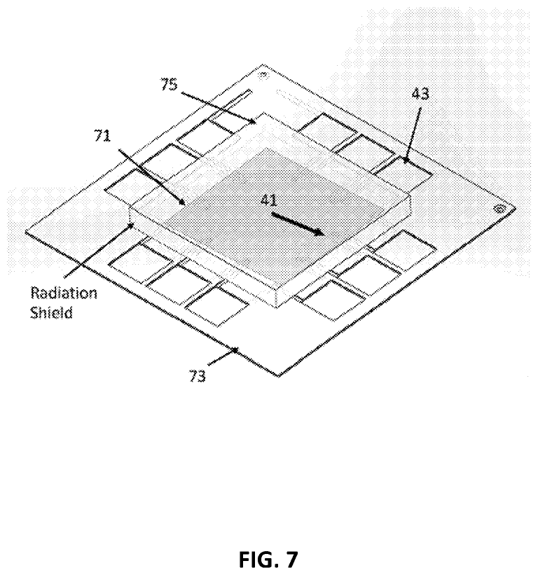

FIG. 7 is a schematic representation of a passive element thermopile design for compact measurement of penetrating radiation dose using the through-hole via design. Shielding is present inside to maintain the cold junction and the hot junctions are on the periphery for this configuration.

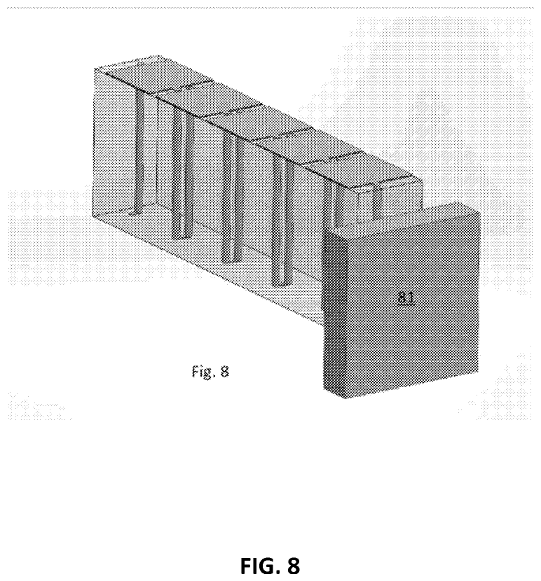

FIG. 8 is a schematic of either of the thermopile layouts which could be configured into a ring for assistance to doctors or medical personnel performing procedures such as fluoroscopy where their hands could be in the radiation field. block 81 illustrates shield which reduces dose to the cold junctions but allows the hot junction to see the main flux. In this instance the shielding is vertical rather than horizontal as in FIG. 7.

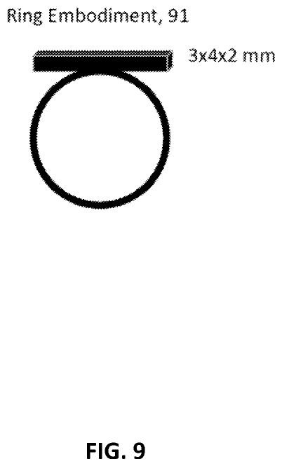

FIG. 9 is a schematic illustration of an example embodiment for a ring embodiment to monitor dose at a practitioner's hand during fluoroscopy. In this case all that is needed is a shadow effect to discriminate dose to hot/cold. Modeling of attenuation will provide adequate high accuracy dose integrated dose to the hand.

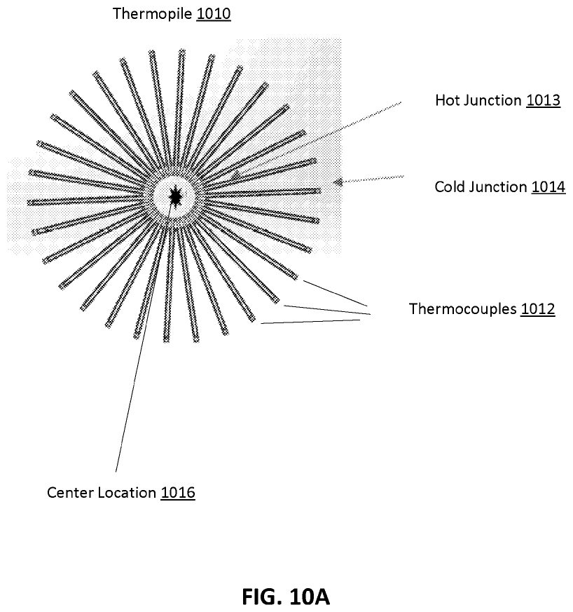

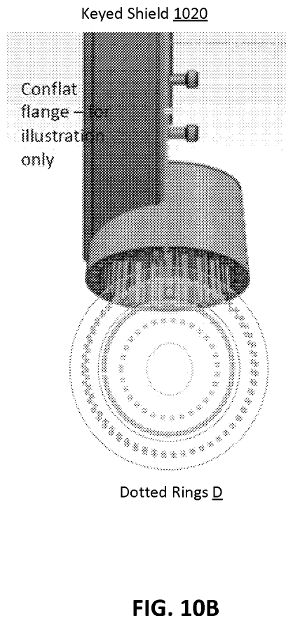

FIG. 10A shows a schematic view of a thermopile 1010, according to an embodiment. The thermopile 1010 can include thermocouples 1012 having a hot junction 1013. The thermopile 1010 can include many thermocouples 1012 coupled in series and positioned circumferentially about the center location 1016. The center location represents a source, which may be along the axis out of the paper. The main leads, in and out, are not shown. Each thermocouple 1012 can have a length in a radial direction greater than a width in a circumferential direction. Each thermocouple includes a set of hot junctions 1013 and cold junction s1014 of that thermocouple.

The thermopile 1010 can be configured to measure a location, a spatial characteristic (e.g., a composition of a material associated with a feature having some size), a radiation dose, and/or a radiation rate of ions received from a radiation source. The radiation source can be, for example, an ion, electron, or photon source, a large area particle source, and/or the particle source such as those described in U.S. Patent Application Publication Number 2023/0260737. The particle source can send, for example, pulsed ions, from a direction that is non-parallel to the length of the thermocouples 1012. The thermopile 1010 can have a time resolution, for example, in the range of about 50 picoseconds to 999 milliseconds. The radiation dose measurement of the thermopile 1010 at hot junction 1013 is inversely proportional to the square distance of the junction from the source. The inverse relationship can generate a dose contrast between the hot junction 1013 and cold junction 1014. The hot junction 1013 can have a radiation attenuation greater than one hundred times a radiation attenuation of the cold junction 1014, if the source is close to the hot junction. The thermopile 1010 can be configured as, for example, an experiment or calibration unit for an x-ray source. In some implementations, the thermopile 1010 can include a shield configured to block background radiation or scattered radiation from the particle source to improve the signal-to-noise ratio of a measurement of the thermopile 1010. In some implementations, the thermopile 1010 can include a temperature controller (not shown) coupled to the thermopile 1010 and configured to adjust a temperature of the environment of the thermopile 1010 to affect a signal-to-noise ratio (SNR) of the measurement.

FIG. 10B shows a perspective illustration 1000B including a keyed shield 1020, according to an embodiment. The illustration 1000B also includes dotted rings D, which are shown as a schematic overlayed onto the keyed shield 1020. The keyed shield 1020 can include cylindrical rings with notches (e.g. gear teeth). The notches can align to shield some junctions of a thermopile from radiation and expose other junctions of a thermopile to radiation. In some implementations, a thermopile can have many layers of junctions. Each layer can be composed of a different number of junctions than the other layers. The keyed shield 1020 can shield junctions at many layers to enhance the signal. In some implementations, the keyed shield 1020 can alternatively shield the junctions of certain layers (also referred to as differential shielding) so that the thermopile functions as a spectrometer. The keyed shield 1020 can shadow a set of detectors to provide improved background subtraction, energy discrimination or be un-shadowed to improve signal-to-noise depending on the need.

Shading illustrates examples of how hot/cold/differential energy/pixelated imaging can be performed, or how spatial resolution in imaging, or all at the same time.

The dotted rings D at the bottom of the keyed shield 1020 can reflect hot/cold junctions and the shielding. Multiple rings provide the option for multiple nested rings of sensors. Depending on scale each point shown could be either a single junction or an array. The array could also be an x, y matrix with corresponding shielding.

Both the layout and the impedance matching can define performance and application. Distance symmetry in the leads between the hot and cold junctions can maintain high timing resolution and minimize ringing effects between sensing elements.

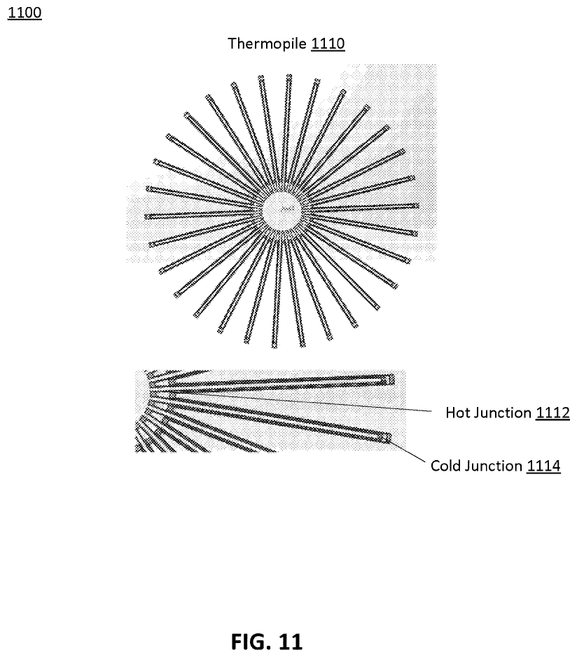

FIG. 11 shows an expanded front view of a thermopile 1110 (e.g., the thermopile of FIG. 10), according to an embodiment. FIG. 11 expands on the concept of using distance to provide differential dose to a hot junction 1112 and a cold junction 1114 on a single substrate. The thermopile 1110 can attenuate radiation between the hot junction 1112 and the cold junction 1114 by over two orders of magnitude, making the background contribution from radiation bleeding between junctions negligible for most purposes. FIG. 11 is meant to illustrate function and is not to scale. In some implementations, for example, the thermopile 1110 can include 750 junctions for characterizing a small point radiation source. The number of junctions can be adjusted for the need/as desired. The thermopile 1110, for example, can be used to calibrate equipment or can be used in laboratory or inertial confinement fusion.

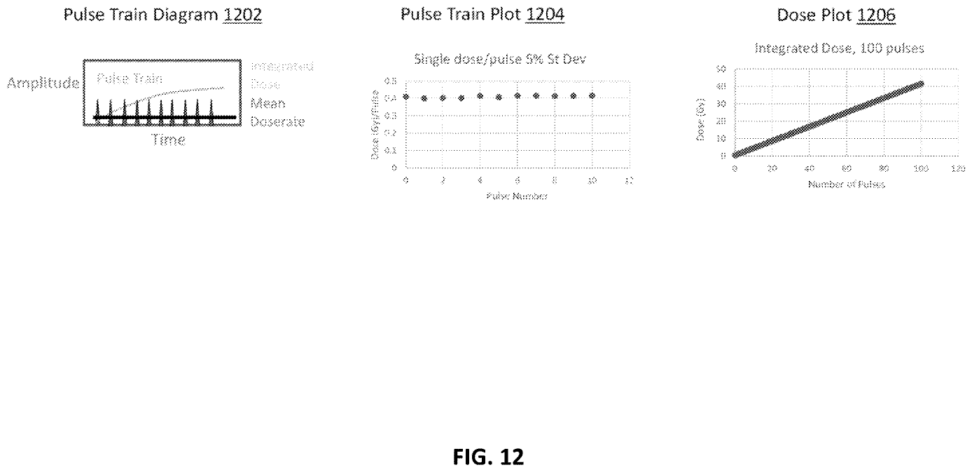

FIG. 12 shows an example pulse train diagram, an example pulse train plot and an example dose plot to convey an example accuracy of pulse-based particle beam sources in achieving a desired integrated radiation dose. More specifically, FIG. 12 shows a pulse train diagram 1202, a pulse train plot 1204, and a dose plot 1206. FIG. 12 shows an example of how many small pulses summed together can result in accurate triggers that can be controlled to cease irradiation to a target from a particle beam source at a defined pulse limit. The dose plot 1206 shows an example of an accurate dose delivered to a target using 100 pulses. The pulse train diagram 1202 shows short pulses of a pulse duration (also referred to as peaks herein) in the range of about 1 femtosecond and 999 microseconds that are sent periodically in time with a given amplitude. The pulse train diagram 1202 and pulse train plot 1204 show 5% standard deviation between pulses. The time between pulses can be used to measure a dose on a detector/sensor of a target and to determine whether to fire an additional pulse. In some implementations, the incremental dose from many small peaks (e.g., 100 pulses, about 10 nanoseconds in length, over a duration of 1 second) as measured by a detector/sensor (e.g., the thermopile 1010 of FIG. 10) can be accurate, for example, to within 1% uncertainty, or within one pulse of the cumulative. For example, if the desired error is 1%, then 100 pulses and the contribution to the uncertainty or dose error will be nominally the error of the last pulse. The algorithm used to control Integrated dose is to measure the dose at each pulse Ni, representing the number of pulses, to make the decision to provide another or not and stop the irradiation at Ni, pulses so as to not exceed a fixed amount of dose. This method sets the error based on the delta dose to plus/minus the amount of an individual dose. For example, if the desired error is 1%, then use 100 pulses and the contribution to the uncertainty or dose error will be nominally the error of the last pulse.

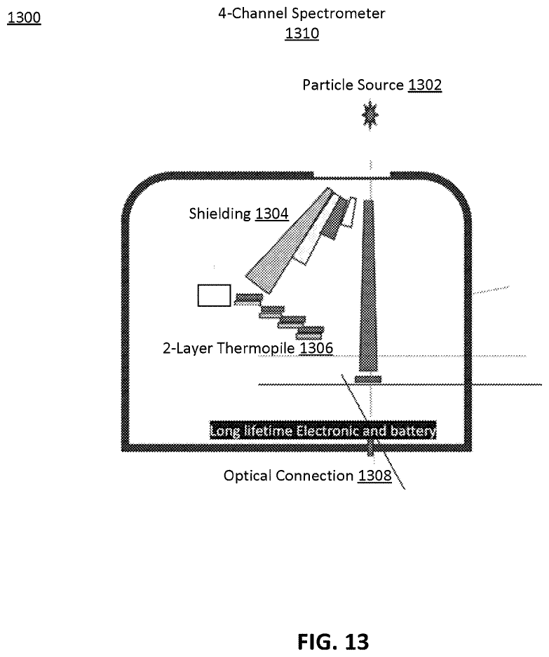

FIG. 13 shows a representation of a four-channel spectrometer, according to an embodiment. The four-channel spectrometer 1310 includes a particle source 1302 sending a pulsed radiation, a 2-layer thermopile 1306, and a shielding 1304 to isolate energy bands of the radiation. The particle source 1302 can be, for example, functionally equivalent to the particle source described in FIG. 10A. The particle source 1302 can send ions to the four-channel spectrometer 1310. The shielding 1304 can isolate energy bands of the ions. The 2-layer thermopile 1306 can detect the ions. The optical connection 1308 can relay a measurement associated with the 2-layer thermopile 1306 to a compute device (not shown) to process the measurement(s).

The four-channel spectrometer 1310 can be optimized for timing, dynamic range and observing small particle beam source 1302 (e.g., an electron, ion, or laser wakefield source). In some implementations, a thermopile 1306 can have many layers of junctions to define a multi-layer thermopile. Each layer can be composed of a different number of junctions than the other layers. This layering contributes to the wide dynamic range of the multi-layer thermopile, which can be used as a wide dynamic (e.g., multi-channel) range spectrometer. The junctions of each layer can be positioned radially about a center point. The orientation of the junctions can provide constant energy filtering for large numbers of junctions at different energies.

The multi-channel spectrometer can be useful, for example, for nuclear forensics where either there is a burst of fission or fusion radiation or experimental work and there is a desire to save lives, reduce social or economic cost of such an event by providing safety guidance.

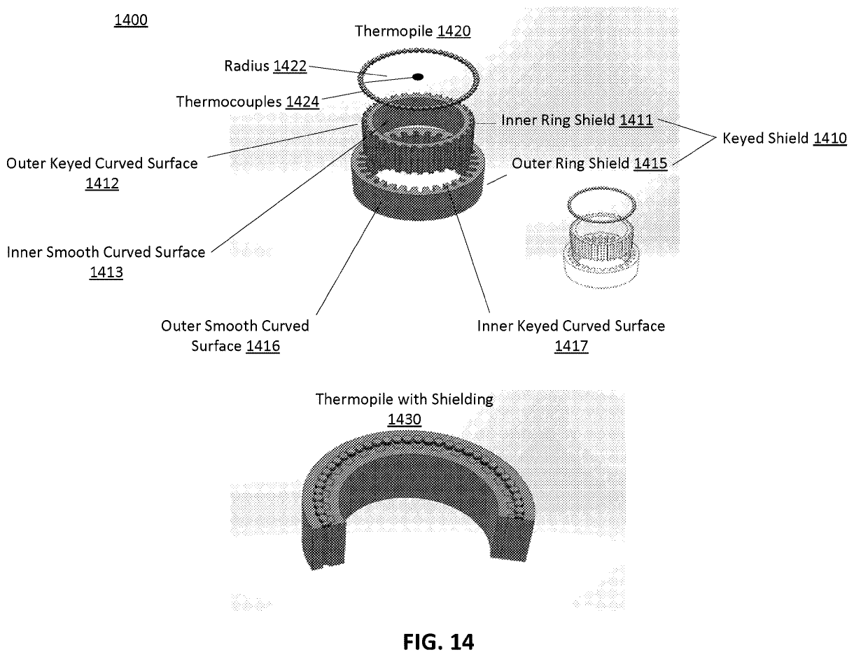

FIG. 14 shows an illustration of a perspective view of a keyed shield 1410 and a thermopile 1420, and a thermopile with shielding 1430, according to an embodiment. The keyed shield 1410 can include an inner ring shield 1411 and an outer ring shield 1415. The inner ring shield 1411 can be a hollow cylinder. The inner ring shield 1411 can include an outer keyed curved surface 1412 and an inner smooth curved surface 1413. The outer ring shield 1415 can be a hollow cylinder. The outer ring shield 1415 can include an outer smooth curved surface 1416 and an inner keyed curved surface 1417. The thermopile 1420 can have a radius 1422 and include thermocouples 1424. A keyed object is to be understood herein, for example, as an object that includes notches (e.g., gear teeth).

The inner smooth curved surface 1413 has a radius less than a radius of the outer keyed curved surface 1412. The inner keyed curved surface 1417 has a radius less than a radius of the outer smooth curved surface 1416. The radius of the outer keyed curved surface 1412 is less than the radius of the inner keyed curved surface 1417. The inner keyed curved surface 1417 of the outer ring shield 1415 has an orientation relative to an orientation of the inner ring shield 1411. The orientation of the inner keyed curved surface 1417 and the orientation of the outer keyed curved surface 1412 can be configured to shield some junctions of the thermopile 1420 from radiation and expose other junctions of the thermopile 1420 to radiation. The thermopile with shielding 1430 is an illustration of a keyed shield (e.g., functionally equivalent to the keyed shield 1410) configured to shield some junctions of a thermopile (e.g., functionally equivalent to the thermopile 1420) from radiation and expose other junctions of the thermopile to radiation.

The thermocouples 1424 can be coupled in series and positioned about a circumference of a circle with radius 1422. Each thermocouple of thermocouples 1424 can have a hot junction with a first circumference position and a cold junction with a second circumference position without an intervening junction between the hot junction and the cold junction. Multiple concentric rings can be used. The structure can also be modified in rectangular arrays or used with phase contrast masks.

The thermopile with shielding 1430 can be used for, for example, general calorimetry. In some implementations, the thermopile 1420 can have many layers of junctions, and a keyed shield 1410 can shield each layer. Each layer can be composed of a different number of junctions than the other layers. The thermopile 1420 can, for example, include many nested rings of junctions, each nested ring being a layer. Many layers can enhance the signal detected and can be configured to perform spectrometry. In some implementations, the keyed shield 1410 can be manufactured by, for example, electrical discharge machining (EDM). For example, another embodiment can include a thermopile with multiple layers, and a keyed shield to shield each of the multiple layers. In such embodiments, each layer can be concentric rings disposed about a center point, where each layer has a radius different from the other layers.

As radiation shielding materials are typically difficult to manufacture, the thermopile with shielding 1430 advantageously allows, for example, use of Wire EDM processes. A single drilled hole can enable the EDM shaping of key internal features of the nesting parts. The part features can be drafted (tapered) such that when assembled all seams are obscured to the propagation of photons. The sense elements are the elements on the back of the keyed shield 1410.

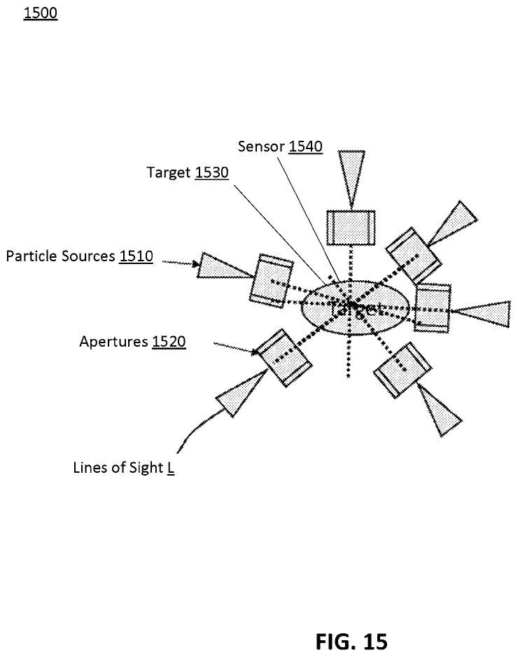

FIG. 15 shows a representation of a system 1500 for tomography, according to an embodiment. The system 1500 can include particle sources 1510, apertures 1520, a target 1530, and a sensor 1540. The system 1500 includes an illustration of lines of sight L overlayed on the particle sources 1510, the apertures 1520, the target 1530, and the sensor 1540. The particle sources 1510 can be, for example, functionally equivalent to the particle sources described in FIG. 10A. The apertures 1520 can be a slit, a slit array, a pinhole, and/or a one-dimensional, two-dimensional, or three-dimensional geometry (e.g., a line, a square, a cube). The lines of sight L illustrate the direction of beams sent from the particle sources 1510 to the target 1530. The particle sources 1510 can be disposed around the target 1530 such that their lines of sight L converge on a plane. In some implementations, the particle sources 1510 can be disposed around the target 1530 such that their lines of sight L converge only at the location of the target 1530 and not at another location (e.g., the particle sources 1510 can be arranged at points along a surface of a three-dimensional object (e.g., a sphere) surrounding the target 1530). The sensor 1540 (not shown) can be, for example, any radiation detecting sensor. In use, the system 1500 can support three-dimensional location measurements of particles, spatial footprint, timing, and additional measurements of the particle sources 1510. The system 1500 can capture more information than, for example, known CAT scans.

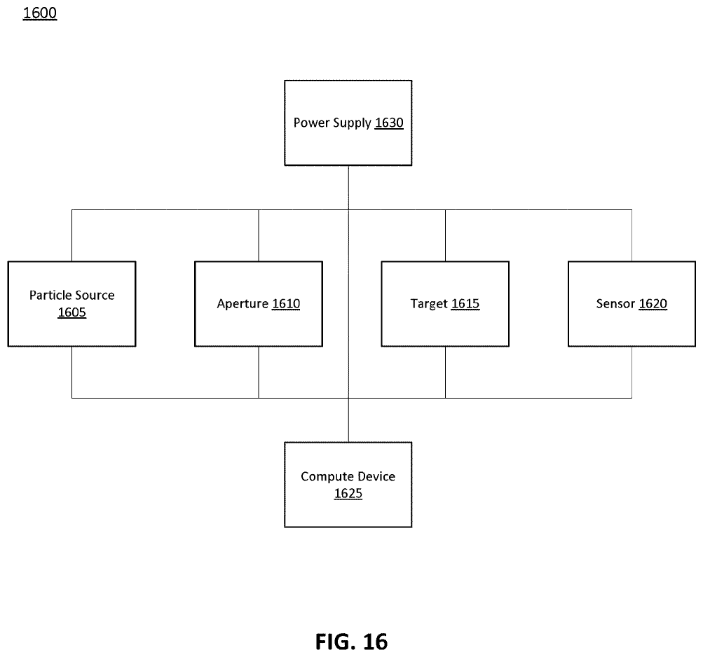

FIG. 16 shows a block diagram of a particle accelerator system 1600, according to an embodiment. The particle accelerator system 1600 can include a power supply 1630, a compute device 1625, a particle source 1605, an aperture 1610, a target 1615, and a sensor 1620. The power supply 1630 can supply power to the other components in the accelerator system 1600. The compute device 1625 can be electronically coupled to the particle source 1605, the aperture 1610, the target 1615, and/or the sensor 1620. The compute device 1625 can be any device configured to execute stored instructions, to acquire data, to analyze data, to process data, and/or to communicate to devices coupled to it. For example, the compute device 1625 can be a desktop, a laptop, a personal computer, a workstation, a server, and/or the like. The particle source 1605 can be structurally and/or functionally equivalent to the particle sources described in FIG. 10A. The particle source 1605 can include, for example, a pulsed photon, neutron, or laser/wakefield source in the range of 5 keV to 999 MeV. The aperture 1610 can be, for example, a pinhole, a penumbra, a zone plate and aiming structure, or a distance spacing. The aperture 1610 can collimate particles from the particle source 1605. The target 1615 can include, for example, a calibration or lab target, a human body or a portion of a human body, or equipment. The target 1615 can receive particles sent from the particle source 1605. The sensor 1620 can be any radiation measuring sensor, including, for example, the thermopile 1010 of FIG. 10A. The compute device 1625 can configure (instruct via instruction signals) the particle source 1605 to send additional particles in response to a sensor measurement (e.g., a measurement indicating a radiation dose that does not fall within a desired radiation dose). In some implementations, for example, the particle source 1605 is a pulsed ion source, and can send pulsed ions to a thermopile configured to measure radiation dose to within 1% uncertainty of a desired radiation dose.

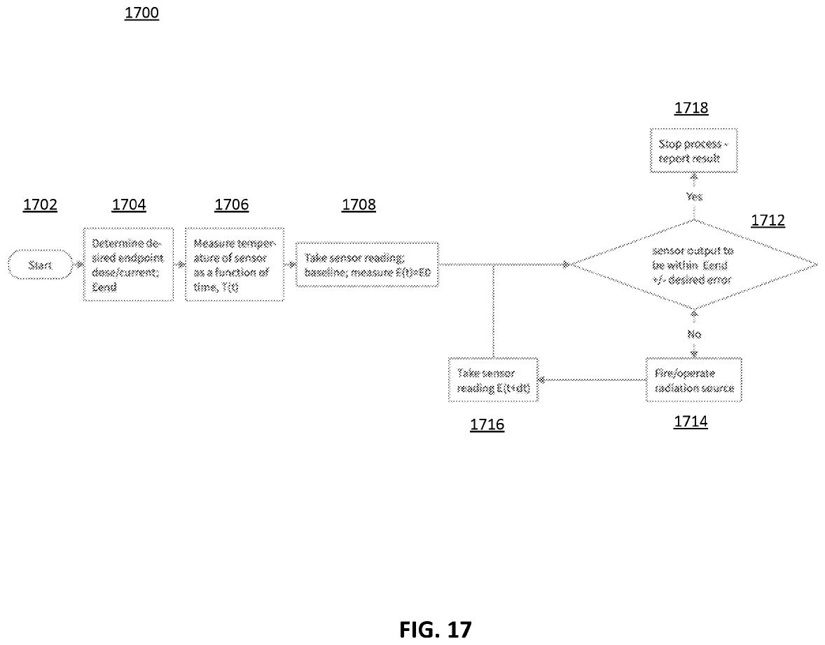

FIG. 17 shows a block diagram of a method 1700 to reach a desired integrated radiation dose having higher accuracies than known algorithms, according to an embodiment. The algorithm 1700 can for example be executed by a compute device of a particle accelerator system (e.g., the compute device 1625 coupled to the particle accelerator system 1600 of FIG. 16). In some implementations, a single pulse can be fired. In other implementations, many pulses can be fired. The method 1700 can be an iterative approach to reach the desired integrated radiation dose where the difference between individual dosages sets the absolute uncertainty. The method starts at 1702. At 1704, the input of the method 1700 is an indication of the desired integrated radiation dose or current, and a desired error value associated with the desired integrated radiation dose or current. The desired error value is also referred to herein as E_{end}. At 1706, two quantities are read and tracked continually while the method 1700 is executing: the temperature of any radiation dose sensor (e.g., the sensor 1620 of FIG. 16) as a function of time (referred to herein as T(t)), and the integrated radiation dose/current as a function of time as recorded by the sensor (referred to herein as E(t)). The sensor can be any radiation dose sensor such as, for example, the thermopile 1010 of FIG. 10A. At 1708, an initial integrated radiation dose/current reading is measured as E(0) and recorded. At 1712, a processor (e.g., a processor of the compute device 1625 of FIG. 16) determines whether the sensor output E(t) is within the desired error value from the desired integrated radiation dose. For example, the processor can calculate an error value between the integrated radiation dose and the desired integrated radiation dose and determine whether the error value satisfies a threshold, the threshold being the desired error value. If the integrated radiation dose is not within the desired error value from the desired integrated radiation dose, at 1714, the particle source (e.g., the particle source 1605 of FIG. 16) sends/fires an additional pulse. At 1716, an additional sensor reading E(t+dt) is taken, where dt is meant to describe a lapse in time from time t. At 1712, an additional calculation by the processor determines whether the sensor output E(t) is within the desired error value from the desired integrated radiation dose. If not, then the process at 1714, 1716, and 1712 including the particle source sending an additional pulse and the processor comparing E(t+dt) against the desired integrated radiation dose repeats until such time that the integrated radiation dose E(t+dt) is within the desired error from the desired integrated radiation dose. At 1718, operation of the particle accelerator system stops and the result is reported. The ratio of the desired error value and the desired integrated dose value expressed as a percentage can be less than 5%, and less than 1%, which is practical.

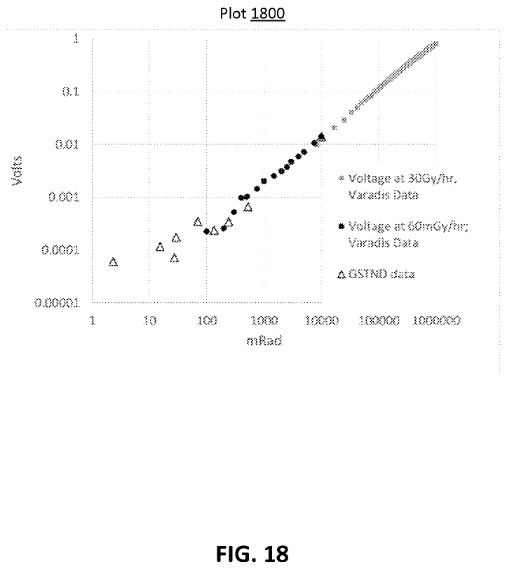

FIG. 18 shows a plot 1800 including sensor measurements (e.g., measurements taken by the sensor 1620 of FIG. 16) and known sensor measurements using measurement techniques and/or systems other than those described herein. The plot 1800 shows empirical data captured by a sensor of a particle accelerator system (e.g., the particle accelerator system 1600 of FIG. 16), after execution (e.g., executing the method 1700 of FIG. 17). The plot 1800 shows a greater than order of magnitude improvement in signal-to-noise ratio of the sensor over known sensors. The plot 1800 has a legend with three data sets, including a voltage at 30 Gy/hr (known data), a voltage at 60 mGy/hr (known data), and GSTND data (data from the sensor after executing the method, according to one or more embodiments described herein). The GSTND data set indicates a more than order of magnitude improvement in signal-to-noise ratio over the two other data sets, the data sets being related to measurement techniques and/or systems other than those described herein.

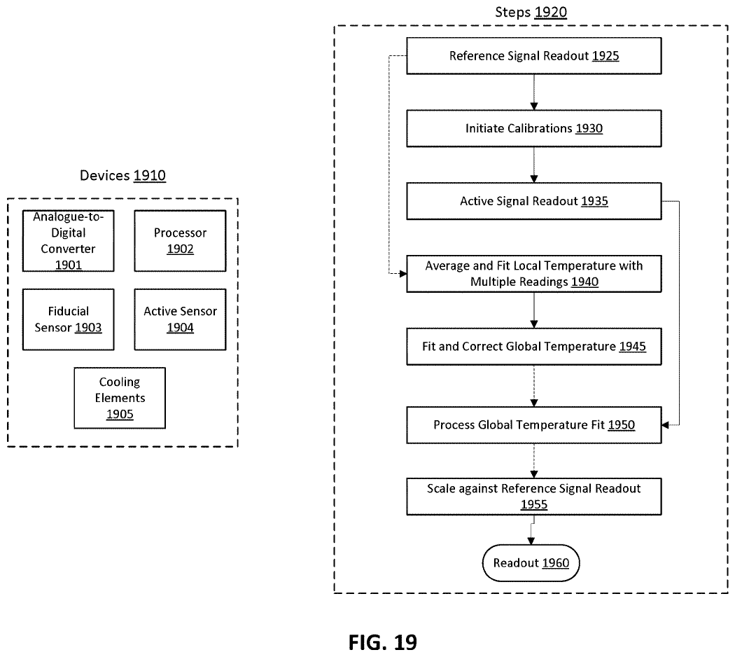

FIG. 19 shows a method having steps 1920 and a block diagram of devices 1910 for implementing steps 1920, according to an embodiment. The method can be used to correct sensor measurements affected by changes in environmental conditions. The method can be used to maintain accurate sensor measurements in response to changes in environment temperature and can be implemented by devices 1910. The devices 1910 can include hardware and/or software. The software can include a program implementing one or more components of the method 1900. The hardware can include, for example, an analogue-to-digital (ADC) converter 1901 (e.g., a high depth ADC), a processor 1902 (e.g., a field programmable gate array (FPGA), a cortex M0, etc.), an active sensor 1904, and a fiducial sensor 1903. In some implementations, the devices 1910 can include cooling elements 1905. The cooling elements 1905 can be disposed at hot spots of the processor 1902 to improve performance. The method 1900 can be a general-purpose algorithm and can be implemented using a variety of sensors. The active sensor 1904 can be any sensor such as, for example, a radiation sensitive field-effect transistor (RADFET) or a thermopile (e.g., the thermopile 1010 of FIG. 10A). The fiducial sensor 1903 can be any sensor such as, for example, a RADFET or a thermopile. The fiducial sensor 1903 can provide a reference measurement (e.g., a voltage) that can be used to help calibrate the active sensor 1904. The ADC 1901 can be electronically coupled to the processor 1902 and can convert an active readout signal of the active sensor 1904 and a reference readout signal of the fiducial sensor 1903. The processor 1902 can execute the software in response to the active readout signal and the reference readout signal. The active readout signal and the reference readout signal can be taken continuously (in real-time) or at intervals of time.

The method can include steps 1920. At step 1925, the processor 1902 can receive a reference signal readout from the fiducial sensor 1903. The reference signal readout can, for example, include a voltage associated with local temperature data of an environment surrounding the fiducial sensor 1903. At step 1930, the processor 1902 can initiate calibrations for the active sensor 1904 using the reference signal readout. The calibration can include a temperature calibration, a dose calibration, and a fade calibration of the sensor using the fiducial sensor. The temperature calibration can be performed, for example, when there is no dose variation in the active readout signal over global temperature ranges. The dose and fade calibrations can be performed when a temperature of the reference readout signal is constant.

At step 1935, the processor 1902 can receive the active signal readout from the active sensor 1904. At step 1940, the processor 1902 can average a local temperature data of the environment over one or more time periods to produce an intermediate data. The processor 1902 can apply a fit function to the intermediate data to produce a fitted intermediate data. Over many time periods, the processor 1902 can produce a global temperature data of the environment based on the intermediate data. At step 1945, the processor 1902 can apply a fit function to the global temperature data to produce a fitted global temperature data and can apply a correction to the fitted global temperature data to produce a global temperature correction. At step 1950, the processor 1902 can apply the global temperature correction to the active readout signal of the active sensor 1904 to produce a temperature-corrected active sensor readout. At step 1955, the processor 1902 can scale the temperature-corrected active sensor readout against the reference readout signal. At step 1960, the processor 1902 can report the temperature-corrected active sensor readout. A temperature-corrected active sensor readout that does not change in response to changes in local environment conditions (e.g., a temperature) is to be understood as flat. Under certain laboratory circumstances the flatness of corrected data was better than 10 ppm. Under some conditions, the method 1900 has worked to better than 1 ppm in temperature correction. In implementations where the active sensor 1904 is one or more RADFETs (thermopiles or other sensor element), there are many parameters that can be used to optimize (or improve) the results such as, for example, the number of reads averaged together, the relay settling time, the Read time, the ADC settling time, and/or the Read Set Delay.

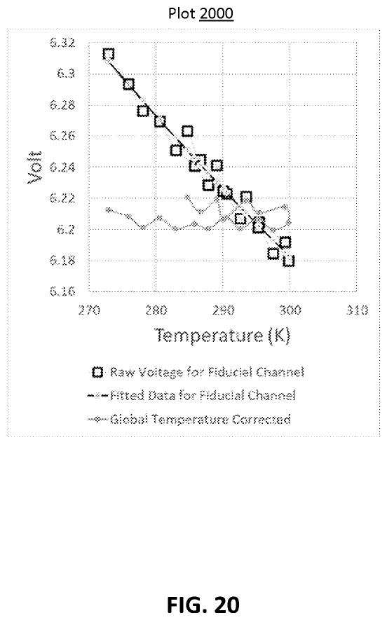

FIG. 20 shows a plot 2000 including sensor measurements. The plot 2000 has a legend with three data sets, including a raw voltage for a fiducial sensor, a fitted data for the fiducial sensor, and a global temperature correction for an active sensor. The fiducial sensor can be any sensor, such as, for example, a radiation sensitive field-effect transistor (RADFET). The fiducial sensor can provide a reference measurement (e.g., a voltage) that can be used to calibrate the radiation dose sensor. The fiducial sensor can measure environmental characteristics (e.g., a temperature of an environment) over time. The active sensor can be any sensor, such as, for example, a RADFET, a thermopile (e.g., the thermopile 1010 of FIG. 10A), or any radiation dose sensor. The plot 2000 shows temperature-corrected data (represented by circles) for time and temperature variation of an environment surrounding RADFET sensors, after executing an algorithm (e.g., the method 1900 of FIG. 19). The radiation dose sensor can compensate for a change in temperature variation to maintain an accurate measurement (e.g., accurate to within 1% uncertainty of a desired measurement or specification). In some implementations, the radiation dose sensor can maintain sensor measurement to within 1 ppm in temperature correction.

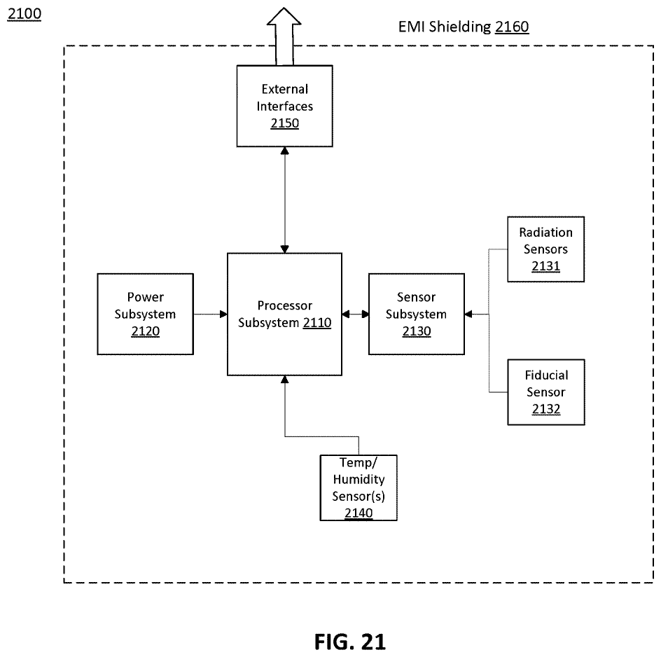

FIG. 21 shows a block diagram of a system 2100 for processing sensor data, according to an embodiment. The system 2100 can include a processor subsystem 2110 (e.g., the processor 1902 of FIG. 19), a power subsystem 2120, a temperature and/or humidify sensor(s) 2140, a sensor subsystem 2130, a EMI shielding 2160, and external interfaces 2150. The power subsystem 2120 can include a battery, power conditioning, and/or a silicon-controlled rectifier (SCR) power supply controller. The sensor subsystem 2140 can include one or more radiation sensors 2131, a fiducial sensor 2132, an ADC (not shown), analog switches (not shown), and/or a current source (not shown). In some implementations, the radiation sensor 2131 can include, for example, RADFETs such as the Tyndall TY1003. The external interfaces 2150 can be an optical transducer. In some implementations, the external interfaces can include one of Bluetooth®, general-purpose input/output (GPIO), auxiliary communications, a display, USB/UART communication protocols, and/or long-range antenna. The EMI shielding 2160 can be, for example, a faraday cage. All transducers and signals associated with the system 2100 (within or outside of the EMI shielding 2160) can include radiation-induced shunts/protection circuitry to avoid permanent damage.

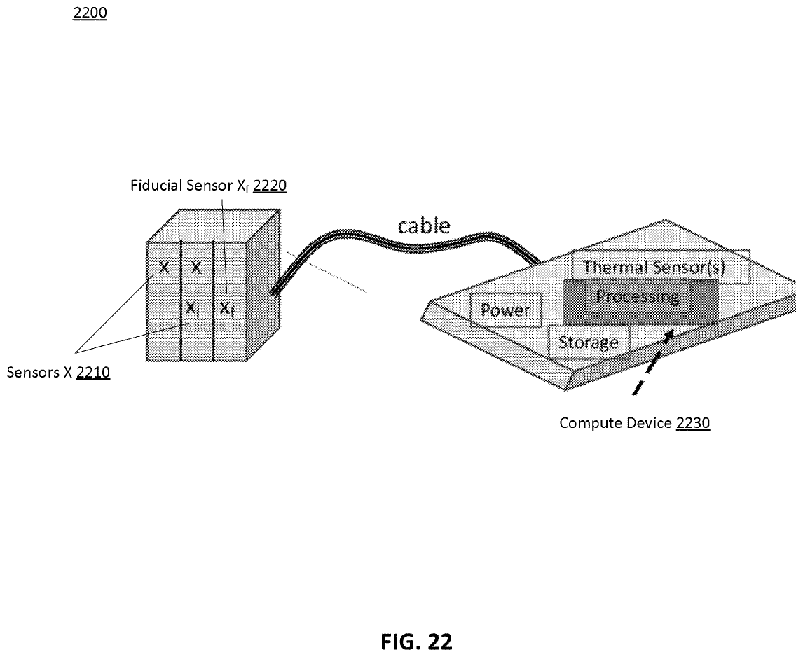

FIG. 22 shows an example illustration of a system 2200, according to an embodiment. The system 2200 can include one or more sensors X 2210, a fiducial sensor Xi 2220, and a compute device 2230. The system 2200 can implement a method (e.g., the method 1900 of FIG. 19) to correct sensor measurements affected by environmental conditions (e.g., a change in temperature of the environment surrounding a sensor). The sensors X 2210 can be any sensor, such as, for example, a RADFET or a thermopile (e.g., the thermopile 1010 of FIG. 10A). The fiducial sensor Xᵢ 2220 can be any sensor, such as, for example, a RADFET or a thermopile. The compute device 2230 can include power elements, storage elements (e.g., memory including RAM, ROM, etc.), one or more thermal sensors, and processing elements (e.g., a processor including a FPGA, IC, etc.). In some implementations, the compute device 2230 can include a pulsed chiller to maintain constant temperature at an amplifier of the compute device 2230.

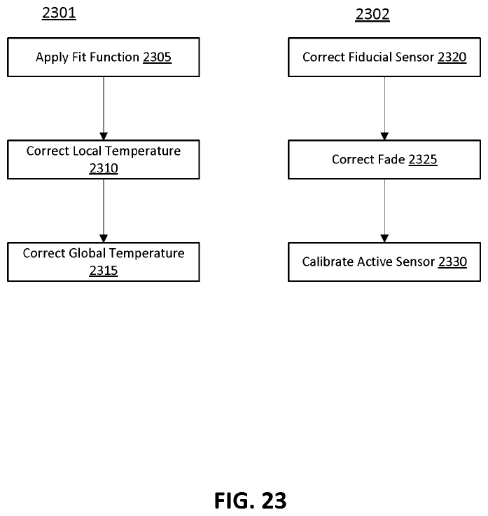

FIG. 23 shows a flow chart for a method 2301 to reduce noise and correct temperature and time-dependence of a sensor, and a flow chart for a method 2302 to calibrate a sensor, according to embodiments. The method 2301 and the method 2302 can be included within another method (e.g., the method 1900 of FIG. 19). The method 2301 includes steps 2305, 2310, and 2315. At step 2305, a processor (the processor 1902 of FIG. 19) can apply a generic fit function (e.g., LINEST in excel) to a raw data to produce a fitted data. Common variants are available for arbitrary order polynomial fits to the raw data. A second order polynomial is used. At step 2310, the processor can correct the fitted data to produce a local temperature correction. The equation for the local temperature correction is given:

V_{TC-local}(volts)=T_{V,raw}(volts)−T_{V,fit local}(294K)

A set of voltage data is obtained at nearly constant temperature for the initial zero dose voltage of the RADFET. At step 2315, the processor can apply a fit function to a global temperature data to produce a fitted global temperature data. The processor can correct the global temperature data using the local temperature correction and the fitted global temperature data to produce a global temperature correction. The equation for the global temperature correction is given:

V_{cglobal}(volts)=V_{TC-local}(volts)−V_{fit global}(294K)

The method 2302 includes steps 2320, 2325, and 2330. A set of voltage data is obtained over the full range of RADFET (or other sensor) operation required without additional irradiation temperature for the initial zero dose voltage of the RADFET. At step 2320, a processor (e.g., the processor 1902 of FIG. 19) can correct a fiducial sensor (e.g., the fiducial sensor 1903 of FIG. 19) to produce a fiducial correction. The fiducial correction is a mathematical duplicate of the temperature correction applied to the globally corrected temperature only using the temperature data from the fiducial sensor. At step 2325, the processor can fade correct an active sensor (e.g., the active sensor 1904 of FIG. 19) to produce a fade correction. There are at least two options for fade correction, including:

Experimental General Case: V(t)=α*exp(−bt)

Arrhenius Specific Case: V(t)_{A}=α*exp(−b(T)*t)

At step 2330, the processor can further calibrate the active sensor. To achieve high accuracy each RADFET can be calibrated by exposure to a known radiation source (e.g., the fiducial sensor) and the parameters of the dose are fitted to the voltage conversion formula provided by Varadis for the Functional Relationship between dose and voltage. Other sensor types will require appropriate conversions.

In medical, national security, laboratory and industrial screening/machinery applications known thermopiles/thermocouples are not typically used for ionizing radiation or penetrating radiation such as gammas or neutrons because of their low sensitivity and sensitivity to environmental temperature changes. No one commercially or commonly measures radiation dose directly because the temperature rise is much lower (read 10,000 to 1 million times smaller) than environmental temperature change in many situations. One or more embodiments changes that for many practical situations. In addition, known thermocouples are not routinely used because the time response is slow compared to the phenomenon of interest.

Needs for faster, more accurate, low power, as well as flexible and low-cost applications for fast penetrating radiation field measurements exist. The algorithms of the one or more embodiments can obtain improved signal-to-noise in these environments, enhancing the utility of the very low signal radiation sensing technologies to more use cases. Using thermal sensors for short pulses can mean that the environmental changes in temperature are negligible and the differential analysis method offers great advantage.

The current or voltage change response of a material when exposed to radiation or an environmental temperature change is a physical property of that material. This is why the applications addressed involve radiation provided on time scales less than roughly 1 ms (meaning millisecond). Most systems cannot make large enough changes in temperature on the timescale of ms to appreciably change the interpretation. In all the applications addressed, improved performance will be observed if the systems are insulated and or chilled (not shown). For example, flash radiography of any type, calibration of medical equipment/radiation producing systems, cancer treatment, laboratory equipment are all appropriates applications for the one or more embodiments disclosed. The one or more embodiments can for example measure a radiation induced temperature rise, image radiation sources, be configured as a energy spectrometer, or provide energy-, space- and time dependent measurements on short timescales.

One or more embodiments concern radiation sensors, specifically sensors that provide measurement of radiation dose and dose rate. Other commonly used radiation sensors, e.g., semiconductors, scintillators, proportional or avalanche gas sensors, thermoluminescent detectors, etc., use some sort of complex conversion to determine radiation dose. Embodiments can use direct fundamental parameters (e.g., the Seebeck effect in a thermoelectric junction (single unit or thermopile (multiple unit)) devices. The effect can be utilized when sensing penetrating and ionizing radiation, and changing background temperatures can be accounted for in the device so that it can be an unpowered device and directly NIST traceable based on the fundamental physics. Embodiments can provide precision and accuracy of 1 percent or better because they can be directly related to dose without conversion or modeling of the x ray source and spectrum.

Medical applications often require precision in both measurement of ambient conditions as well as low noise, high gain amplification of the thermopile output. Short pulsed x ray sources, such as those used in most x ray machines, allow direct thermal background measurements, as well as radiation shielding near hot and cold junctions, to discriminate environmental effects from the radiation desired to be measured. Powered devices can be used or not as the specific need for a RTD or thermopile solution requires. Depending on the source energy, differential shielding or longer leads can be used to separate the hot and cold junctions. The separation between the hot and cold junctions is important for measuring penetrating radiation; this separation helps to maximize the temperature difference seen between electrodes. Under some conditions it is enough to have different sized junctions and thermal features, however, for the best measurement of temperature rise due to the radiation it can be preferred if one junction does not get radiated at all. Hence the shielding. Where these systems will not easily compete is in the arena of high sensitivity devices-bulk scintillators and other technologies will be far more sensitive and manufacturable in much larger volumes for a long time.

Additionally, by design the materials can determine the method for obtaining and maintaining a thermal gradient across the sensor elements. By design the thermopile has a cold plate, cold junction of high heat capacity, the hot side has low heat capacity and high equivalent thermal mass (e.g., vacuum). Another embodiment is for softer x rays (such as dental, nominally 20 keV) for this just use a through hole design with vias. We described a number of designs for highly energetic penetrating radiation that are useful in many situations including but not limited to medicine, device calibration, laboratory experiments, neutron generation, astrophysics, basic science, fusion technology (particularly Inertial Confinement Fusion, oil well-logging and mining and detection of weapons of mass production, nuclear forensics. The choice of method will depend on specific cost/benefit analysis for a specific application. The one or more embodiments, however, can work in each of the applications mentioned.

Embodiments provide a radiation self-powered trigger as well as a monitor for dose and dose rate. It can serve as a passive signal integrator and amplitude hold capacity or be used with continuous acquisitions systems such as oscilloscope or digitizers. These can enable low power circuitry as well as an inherently radiation-hard capability. The dose can be stored for a short time, while electronics are off, to enable survival of the signal. Normally at high doses electronics will fail or system generated EMP will affect performance. Embodiments of the invention can enable operation in normal rate, to high dose rate, and to extremely high dose rate environments as compared to most terrestrial environments.

Embodiments provide for fabrication, assembly, operation of an electronic circuit that can operate as an accurate, compact, inexpensive, low-power, dose rate and/or dose detector for an extended range of radiation dose rate and dose for total dose, as well as separate gamma and neutron radiation. An example circuit embodiment works for both moderate total doses and for the high dose rates that are generally classified as prompt radiation events. The definition of 1 rad of radiation dose is 1 erg/g. This is a source of difficulty: the background radiation dose is 600 mrad/year, and the LD 50/30 is 600 rads. An example circuit embodiment can have elements that compensate for thermal background variation in time domains that are not the same as the imposed radiation event. Because of the reliance upon basic physical parameters of the thermocouple materials the device is inherently traceable to NIST standards. Unlike other technologies, embodiments can be very radiation hard (insensitive at high doses) and the readout electronics can be near the sensor or remote from it. This can be responsive to the need or concept of operation and the sensitivities of the electronics used to read the response.

Because the sense element can be implemented as a bimetal junction, rather than a volumetric sensor such as a scintillator, the device can be small, and can be made in arrays for imaging to diagnose medical dose immediately and accurately. It can be used to diagnose accidents or malicious acts as well as work in most environments where penetrating radiation is a concern or needs to be monitored.

Embodiments provide a direct measurement of temperature divided by known heat capacity, a clean way to measure total dose. Using a thermocouple whose voltage is provided by the well-known Seebeck effect gives a temperature directly tied to a physical constant and is therefore fully traceable back to NIST standards. The sensor element itself can be unpowered and totally passive.

The Seebeck effect can be used to measure ergs/gram or radiation dose directly. It is not ordinarily used for measuring radiation for a single junction since normal radiation doses will have picovolt (pV) changes and these are much, much smaller than can be measured with current electronics. Further, in a normal junction the two ends must be at different temperatures for the Seebeck effect to be measured. With penetrating radiation when the junctions are close together then the state-of-the-art has to date not determined a way to drive a meaningful radiation-dependent temperature change at medically relevant dose rates. Further, the background thermal temperature changes will dominate the Seebeck effect, making the signal due to radiation much less than the noise measurement.

Embodiments can overcome all of these hurdles. Embodiments use thermoelectric effects to improve performance over the current state-of-the-art and to enable measurements not currently viable. In some implementations, the embodiments are passive (no power). In other implementations, the embodiments are resistive or active. Such designs require control of the currents and voltages well enough to trust the output as much. The tradeoffs will be in sensitivity and cost versus accuracy.

Embodiments combine a technique to correct for thermal drift in the background as well as signal enhancement to reduce amplification requirements over use of a single element. In addition, this can extend to unpowered sensor elements, with unpowered signal holding until the main power is turned on. This feature can enable the electronics to be off while the irradiation is above normal operation levels so that the measurement can still be made. This can be important for operation through a prompt or intense radiation pulse where most electronics can fail due to radiation or SGEMP (Signal Generated Electromotive Pulse) damage. Amplification and storage of the signal can still be required. These features can be desired for space based as well as terrestrial environments. The effect in a time domain context of something like a Fukushima event (hours) or nuclear explosion (ns-hours) is illustrated in FIG. 3. A important aspect of how this works is that the radiation pulse is much faster than the environmental change in temperature. The signal initially starts at the background dose rate. After the event occurs, the signal has a sharp rise. This sharp rise can cause conventional electronics to fail and can disrupt conventional equipment. The signal then has a delayed decay portion as time passes since the event. There will be an intense burst of radiation, enough to overwhelm and potentially damage many sensors. At lower levels this same thing happens during a medical x ray and various procedures can happen quickly and some take longer. The dashed line shown represents a change in temperature background as long as the background temperature variation is known and can be corrected for then the difference is a direct measurement of the penetrating radiation dose because the inverse ratio of the Seebeck Coefficient divided by the heat capacity times the voltage is the ergs/g. That is the direct measurement of the dose. The effect shown in the figure can also relate to a CAT scan and a signal at a distance from a terrorist nuclear event as well.

Known high dose sensors use active circuit measurements and charge depletion (semiconductors) for dose measurements. They saturate at high doses and need complex calibration. Variants of this are true for most sensors currently in use, including scintillators, Geiger-Mueller tubes (gas avalanche) and semiconductor sensors.

Using the inherent voltage drop across a thermocouple means that the measured response is due to the inherent dissimilar response of the metals to temperature providing known thermoelectric effect (the Seebeck effect). This means that the sensor is inherently calibrated and unpowered. A direct measurement of temperature divided by known specific heat capacity (e.g., ergs/kg-K) is a clean way to measure total dose which is defined in terms of ergs/kg or ergs/gram. Using a thermocouple whose voltage is provided by the well-known Seebeck effect gives a temperature directly tied to a physical constant and is therefore fully traceable back to NIST standards. The dose can be found according to dose=dt=Cₚ/S_{b}*dV, where dose is the dose in rads, Cₚ is the specific heat capacity in ergs/K-kg, the Seebeck coefficient, S_{b} is the voltage change, dV, per unit temperature (uV/K). The trick to accuracy is then knowing the heat capacity, the Seebeck coefficient and the change in voltage. The two materials constants and the change in voltage are known and can be measured accurately.

A comment on units. We use various units throughout this specification and attempt to stay with commonly used ones. We assume the reader is well enough versed in the fields to be able to convert units.

This system can provide a ‘gold standard’ measurement of moderate radiation dose and dose rates, meaning NIST-level documented dose and dose rate measurements in a low power package. Two or more differing types of thermocouples (see FIG. 2) can be placed in a thermally insulated package and background signal for environmental temperature adjustments subtracted. The thermocouples offer differing differential sensitivities and heat capacities. In the presence of a radiation field the responses will differ and the subtracted signal in the presence of a radiation signal reflects the heating from radiation alone over the time period of the thermal response of the unit. High gain amplification can be used to see the small heating effects from radiation in most cases. Because dose is defined as energy per gram, the temperature rise directly determines dose.

If the dose rates are too high for direct digital manipulation, e.g., the processing electronics will be disabled by radiation at that dose rate, then a passive sample and hold circuit, such as those known in the art can be used so that the needed signal recorder can be turned off during the event (this is routinely done with a silicon rectifier circuit) and restored once the dose is reduced to acceptable levels. When digital electronics can be turned on the signal can be captured and exfiltrated via wired or wireless means for complete processing.

Changes in environmental temperature, normal variation in temperature through the course of a minute, hour day or year can be very large compared to the dose of radiation that one needs to measure and embodiments provide, using a second thermopile array of differential performance as described in the equations below or by use of another thermal sensor, to subtract or otherwise correct for these variations.

Embodiments can use two or more dissimilar units to correct for environmental variations in temperature allowing for correction of normal background temperature drift and separating the heating elements associated with radiation.

The voltage drop or EMF (electromotive force) across bimetal junctions is well known. See FIG. 2, taken from https://www.iomega.com/techref/pdf/z2016.pdf for an overview of such materials. The shaded areas represent two examples of good choices for paired thermocouple materials. A simple model for a given bimetal junction has the voltage drop, or relative Seebeck effect across the junction, expressed as:

ΔVᵢ(t)=Sᵢ(T)*ΔT(t)

where the voltage drop of the ith bimetal junction as a function of time (t), Vᵢ(t), is the product of the metal's Seebeck effect, Si[V/K] and the temperature. See FIG. 2 for some physical parameters of materials relevant to this description. There is a tradeoff between the number of thermocouple junctions and amplifier gain and the analogue to digital (A/D) converter that will determine how useful these devices are for any application. We give some simple examples in FIG. 3. Note how with an A/D converter, amplifier combination that gives a sensitivity over 1e-9 V (difficult but achievable; and greater than 10 V has been done). The device will give the ability to measure doses for routine x rays, gamma knife, and nuclear events. Variations on this design to enable more applications will be apparent to those skilled in the art.

The temperature can be considered as the sum of an environmental component and a radiation-induced temperature change or T(t)=Tₑ(t)+T_{rad}(t). The environmental temperature can be made to vary slowly in time by insulation or other design characteristic and T_{rad,i}(t) due to the radiation is related to the dose [cGy or rads] and is given by:

$${T}_{rad} ( t , K ) = \frac{R ( t )}{{C}_{i}} * 2 \text{.39} \times 10 - 8 cal / erg$$

where R(t) is the dose and Cᵢ is the heat capacity of the ith thermocouple [cal/g-K]. Tₑ (instantaneous device temperature or environmental temperature) can also be solved simultaneously as this is a system of i-equations and i-unknowns. This provides a powerful technique for both penetrating radiation and thermal radiation in low power devices. Note this is a very small number, for instance, a single junction of C=0.1 cal/g-K will have a temperature variation of 2.4e-7K. To get a 1 rad step change with a 10 uV/K junction and no thermal diffusion effects can require a 2.4e-12 V (or 2.4 pV) measurement.

To put this in perspective see FIG. 3. FIG. 3 relates events that a radiation sensor might need to respond to, and it sets the engineering parameters, such as number of junctions, for aspects of device design. It is relatively easy to measure 1e-4 Volts and with some effort and expense to measure 1e-12 V (1 pV can be measured with effort). This means, in this estimate, that a 10,000 element array is a feasible device to accurately measure the dose from a medical x ray with a nominal 200 uV signal. Measurement of gamma knife irradiations can benefit from more junctions, more signal amplification/noise reduction, or a combination thereof. Systems such as those used with patch clamps can directly measure picoamps.

There are also efforts to develop x-ray sources bright enough to deliver a typical X ray in about 100 ns. With this type of x-ray source from a pinch or dense plasma focus, the equivalent signal is 1 mV or greater.

Instantaneous measurements of damaging doses to tissue can be made and imaged in time to shut down critical equipment prior to someone being overdosed or damaged. This type of circuit can prevent medical tragedies.

Note that any device will be affected by thermal diffusion. Those skilled in the art can model and account for those effects in their usage. The figures illustrate different ways to account for this and to design for short pulses or long ones, long being >1 second and short of order of nanoseconds. Pulses shorter than milliseconds might not need a large correction for thermal diffusion away from the sensing element.

Using more than one junction type allows embodiments to measure the thermal and radiation effects differentially in more than one type of junction. Since the heat capacities are different the equation governing the voltage measurements can be parsed to determine the environmental temperature change as separate from that due to the penetrating radiation. FIG. 4A shows an example simple thermocouple and pile configuration. A first material 51 and second material 52 together form a plurality of thermocouple, one in each region of overlap 41, 42. The thermocouples can be configured to experience different temperatures after exposure to radiation, as examples by placing thermal insulation between them; by placing alternate thermocouples in communication with a cold plate, heat sink, or other thermal management system; by shielding alternate thermocouples from incident radiation; by making the thermocouples such that alternate thermocouples have different heat capacity or conductivity, or any combination of the previous.

The series of thermocouples are in communication with thermocouple measuring junctions 44, 45. The junctions are typically in communication with a circuit, comprising an amplifier, and an analog-to-digital converter (A/D) and the input and output electrodes complete the circuit. The voltage output of the A/D converter is read by an oscilloscope, chart recorder or electronic analogue as a storage medium. The functionality of all of these can be included on a single chip or Floating-Point Gate Array (FPGA). Labjack and National Instrument equipment are examples of suitable equipment, and there are many options known to those skilled in the art. Those skilled in the art will also appreciate implementations using custom embedded circuitry.

One or more embodiments are particularly useful in the arena of nuclear forensics or situations where the primary electronics may saturate, will not work, need to be reset or for other reasons cannot be trusted. The output of a thermopile array can be stored by a parallel set of resistive-capacitive circuits in a passively time-filtered circuit and then can be configured to read the voltage, after the circuit has powered on, and capture data (i.e., dose at time below the filter cutoffs of, for example, 1 us, 100 us, 1 ms, 10 ms). A Cortex-M0 processor and circuit digitization circuit, for example, has a relatively short turn on time. In this case the entire circuit can be powered down or at very low power, until the thermopile output (e.g., 0.1V) is used to trigger the processing elements of the circuit. SCR (silicon rectifier circuits) have been used (see, e.g., www.aquilagroup.com) to power down sensitive circuitry and after a period of time power it back up. With the use of the thermopile as a passive voltage generator the circuit can be off for long periods and then triggered to turn on the read process allowing lower power use.

One or more embodiments can use an array of thermally activated elements to add a small amount of voltage with each consecutive junction. That means fabricating large arrays, e.g., 100 to 1,000,000 or even more junctions, including the methods described for background correction from environmental changes and to provide a temperature difference. One or more embodiments (large and small electrode, high and low conductivity materials, high and low heat capacity materials) such as those shown in the figures can extend the temperature differences between the hot and cold electrodes, and shielding and distance can physically separate the penetrating and ionizing radiation from heating both the hot and cold electrodes. FIG. 4B illustrates an example surface fabricated system. An input electrode 44 is connected to a second material 52, which forms junctions with a first material 51. The materials overlap in the regions indicated, with the junction formed by the materials as they touch in the area of overlap. A cold junction 41 is small with less thermal mass. Hot junctions 42 are large with more thermal mass as shown in FIG. 4B.

FIG. 4C shows many of the junctions made in series to raise the relatively small temperature rise per junction to a quantifiable level. The device of FIG. 4C can be made by repeating the device of FIG. 4B. The example in the figure is a 512-unit pattern. The junctions are connected in electrical series between an input electrode pad 45 and an output electrode pad 46. When two roughly identical systems (for example using Materials 51 and 52) have different materials with differing responses to the thermal background, those systems then can separate the background result and obtain the penetrating or ionizing radiation component of the total temperature. This complexity isn't always needed however it can help bring the signal from penetrating radiation above the thermal background noise.

FIG. 5 illustrates heat transfer aspects of embodiments. The first 51 and second 52 materials can be used to form thermocouples on one or both sides of a thermal resistance material substrate 53. The materials overlap such that there is a junction in each region where the materials overlap. Heat flux, q″ exits the junctions. In operation, the larger hot junctions 43 have greater heat capacity than the smaller cold junctions 41, and, as the junctions heat or cool, the resulting temperature differential will cause voltage differential between the ends of the array of thermocouples. This is quite reasonable for photons below nominally 200 keV. This is adequate for chest x rays and lower energies. The entire system can be quite small. The device shown can be repeated for multiple stages to an output electrode (not shown). A radiation-shielding material can optionally be disposed of such that it blocks the cold junctions from incident radiation, further contributing to the temperature differential.

Note that if both junctions are at the same temperature, then there is no Seebeck effect or voltage to measure. These examples show embodiments for each case-large separation whereby the radiation field at the hot and junctions are different or where dissimilar materials are used to enhance cooling, or high heat capacity on one end and heat capture or low heat capacity at the other.

The problem of a very low signal in a single junction can be overcome by placing many junctions in series, see FIG. 4C and FIGS. 6, 7, 8, 10, 11, 13 for various fabrication styles. The thermal effects, however, should be compensated for in ways that cannot be done as is done in current thin film or MEMs systems with multiple junctions. FIGS. 6-8 provide schematic illustrations of example embodiments that can generate adequate signal and correct for the effects of the penetrating radiation.

FIGS. 4B and 4C illustrate a surface plating/coating process for making a massive array of thermocouples. FIG. 6A (schematic, in section) and FIG. 6B (perspective) illustrate an example embodiment using through-hole via fabrication that can provide generate adequate signal and correct for the effects of the penetrating radiation by using controlled heat capacities and junction parameters on ‘hot’ and ‘cold’ sides to develop voltage differences with penetrating radiation. Substrate 53 comprises an insulator with holes that have been filled with copper or two materials 51, 52. In FIG. 6A the vertical portions of the elements made of the two materials are vias in the substrate. If the vias are filled with copper or another conductive material, then the material 51 or 52 is disposed at the ends of the copper-filled vias. Substrate 53 can be a temperature-controlled surface such as a thermoelectric chiller which is electrically separated from the other elements of the sensor. The elements are connected in electrical series until the first 44 and last electrodes 45 in the series layout. The first and last electrodes are then coupled to the read electronics (not shown). The read electronics will comprise a filter set if needed, amplifiers, impedance matching circuits, if needed, and then the analogue to digital readout and storage. After the storage will come processing and exfiltration of the data to its more final analysis stage. The arrangement shown can comprise a single row or column of an array of sensors, connected overall in series. The number of junctions in each row or column can be more or less than the number shown in the figure. Those skilled in the art will appreciate other geometric arrangements of the elements that still yield the alternative hot and cold junctions.

To facilitate the desired temperature differential, a radiation shield can be deployed to reduce the radiation reaching the cold junctions. The hot junctions can be placed in communication with an insulator, e.g., a vacuum. The cold junctions can be placed in communication with a cold plate, heat sink, or other heat dissipation feature. The hot junctions can be made larger, as shown in the figure, to provide greater heat capacity than the cold junctions. Combinations of these techniques can also be used.

The embodiment of FIG. 7 comprises a device fabricated like that in FIG. 4 with a different layout. A cold plate 71 can be placed in communication with the cold junctions 41, for example on top of or underneath the region containing the cold junctions. underneath. The cold plate 71 is in contact with the thermocouple materials on the first side of a thermal resistance material. The other side of the thermal resistance material is in a vacuum, such that the hot junctions cannot readily dissipate heat due to incident radiation. The junctions are mounted on a substrate 73 that is thermally conductive but electrically insulating. Above (or below or surrounding) the cold junctions is a radiation shield, 75. The thermocouples are disposed on the surface of the substrate such that the cold junctions are near each other, facilitating efficient heat communication with the cold plate or other heat dissipation element. This enhances the temperature differences from the hot junctions to cold junctions based on the heat capacity differences in the materials.

Such arrays can also be stacked on top of each other, for example two arrays can be disposed, one on each side of the cold plate, increasing (e.g., doubling) the number of junctions contributing to the measurement. The thickness and the properties of the various materials can be selected so that the temperature response is appropriate for the intended dose rate and application, allowing the entire unit to be completely passive (requiring no active cooling or heating). The embodiment is sensitive to radiation from any direction. This embodiment can be implemented as a small device and can be manufactured with known machining and assembly methods or using MEMs and microfabrication techniques. The thinner (e.g., 10×) thermocouple junctions, near the cold side can be made so as to rapidly equilibrate with the cold source. The thicker junctions on the vacuum side can retain heat longer to extend the time response. A single junction will provide good signal to noise in a 10 M Rad/s dose environment. 10∧4 junctions will work well in 1e3 rad/s environments or greater. The designs of both FIG. 4 and FIG. 7 can be reconfigured to make the distance between the hot and cold junctions many centimeters. Because wafers are made in multiple diameters (ex. 4 inches to 12 in diameter), variations of either design (flat or through-hole) can made with adequate separation to provide shielding useful to energies above 10 MeV. For instance, a wafer with many cm distance between the cold and hot junctions can be made and shielding provided. These examples can be useful in high energy physics, inertial confinement physics and pulsed power environments. This distance can provide shielding to extend the design into the many MeV of photon energy for extremely penetrating radiation and this is useful for nuclear forensics, for laboratory work and for basic science studies with laser, pulsed power, or beams.

The embodiment of FIG. 8 comprises a device like that in FIG. 6A and FIG. 6B. in this example embodiment, designed for more penetrating radiation and/or higher level of discrimination against environmental effects, a photon shield 81 is added. The shield can comprise a Hi-Z, high density material such as tungsten, and provides shielding for the cold junctions. This embodiment can also be suitable for machine monitoring (medical x ray or simulation sciences, laboratory experiments, etc.) measurement of penetrating radiation dose. This embodiment can be implemented as a small device and can be manufactured with known machining and assembly methods or using MEMs and microfabrication techniques. The example shown can also comprise a single row or column in an array of junctions, connected in series for high sensitivity.

A single junction can provide good signal to noise in a 10M Rad/s dose environment. The specific usage can define the number of junctions required and the number can be varied to generate high dynamic range.

FIG. 9 is an illustration of an example embodiment and packaging for ring scale unit. This type of unit can be suitable for medical dose of record using thermopile and low gain amplifier to Bluetooth or another transmitter. An example is that a 40×40 array of thermocouples can fit on a 5×4×1 mm device, and a small battery can provide power to a transmitter and amplifier (or a thin power line) to exfiltrate the data. In a two-sided configuration with parameters as described herein, this embodiment can hold 3,200 junctions making the ring adequate for time-resolved dose measurements below 200 keV in photon energy. 12,000 junctions can be feasible. A simple battery system can provide 3 hours of operation with currently available electronics. The technology is suitable for medical dose of record because the sensor itself is tied to the fundamental Seebeck phenomenon and the entire electrical path can be calibrated at any time with the addition of a VCSEL (or other light source) or thermal heater built into a chip. In this way the entire system can be calibrated and tied to a physical phenomenon. This method of calibration results in better calibration than those of TLD (thermoluminescent detectors) or OSL (Optically Stimulated Luminescence) which is another contender. An example ring 91 can be 3×4 mm×2 mm and contain a transmitter and battery. Ring 91 is mounted with a thermoelectric chiller 92. The ring can be worn by medical professionals, emergency responders, etc. This type of unit can be suitable for medical dose of record using thermopile and low gain amplifier to Bluetooth or another transmitter. The technology is suitable for medical dose of record because the sensor itself is tied to the fundamental Seebeck phenomenon and the entire electrical path can be calibrated at any time with the addition of a VCSEL (or other light source) or thermal heater built into a chip. In this way the entire system can be calibrated and tied to a physical phenomenon.

By tiling, making an array of sensors (not just junctions), similar elements to those in the ring, a sheet of many of the sense elements can make a flexible imaging array. In this manner the devices can be used to image radiation dose in time with the same extraordinary accuracy. This type of unit is suitable for medical dose of record in an imaging format. The example embodiments described herein can be used without assisted voltage amplification or with it, depending on brightness and embodiment design tradeoffs. Even with 10,000 junctions the signal level can be small. A commercial amplifier such as, for example, the Alligator technologies USB-PBP-S1 and a Lab Jack T7 can, however, amplify the signal level at a single junction E and T-type to useful signals with 100× to 10,000× gain. This gain resulted in thermal level DC voltages that are difficult to compensate. The thermopile design will fix this problem. Thermal noise background in the amplification stage was the greatest noise problem. Serial junctions with lower gain amplifiers with larger gates or HBT electronics which are inherently less sensitive to radiation, can through gain boost the signals into the volt range and suppress the thermal background as well as parasitic defects caused by radiation in the active analog electronics, with capacitive blocking and other techniques.

The direct or amplified voltage of the thermopile can be used to turn on, or trigger, downline digital or analog circuitry using passive or active elements reducing power loads and radiation damage in high environments simply by having the circuitry off during the highest points of the radiation pulse.

The sensing elements can be collocated with processing electronics or be physically separate to provide a reduced radiation signal at the electronics; a sample and hold can be placed on the signal providing additional flexibility in the concept of operation of the assembled device (e.g., for battlefield vs operating theater, etc.).

For one application, soldiers might get exposed to nuclear effects from nuclear weapons, accidents or terrorist events and the need is for tools to provide triage information. Therefore, the circuit should provide a useful readout and survive ~10 Mrads/minute (for instance 1 Mrad/min*1 ms-burst=17 rads) as well as provide an accurate reading of the dose. Embodiments allow use of a simple analog circuit as the sensing circuit coupled with a circuit that is somewhat radiation hardened to provide real-time accurate readout in the field. This addresses two problems: (1) a sensor useful in the biological regime and (2) a readout which is insensitive at the doses and dose rates required. Another common need for such devices is in medical situations, both to protect and monitor the staff as well as patients both during and after procedures.

With low energy radiation the effect is essentially a surface effect, hence the use of resistive and thermocouple arrays for IR radiation. One or more embodiments are also suitable for high energy and penetrating radiation. This complicates the use of these sensor elements because in accurate/normal use the Seebeck effect requires a cold junction or reference temperature at one end of the junction wires. For some circumstances, such as when a known time marker or trigger can be provided, such as for a short burst of radiation where long cables (long may be a few cm and they can be built into a wafer) can be used to move the junction away from the radiation source, a simple background subtraction technique can be used to correct for thermal drift. For other usages, the sensor and the reference back plate will be seeing the same radiation field; this is possible by using a backplate of a material with a very different thermal heat capacity.

Because the sensor is meant to be used for intense bursts of radiation, non-linear effects from changes in background are not needed for many measurements. To obtain the most accurate measurements, corrections for both environmental changes in temperature and relative humidity can be made with high accuracy. There are many gauges on the market with the needed accuracy, one example is the EI-1050 sold by Labjack, baseline temperature and humidity can be modified, and simple linear or higher order fits can be used to adjust for background changes while the variation in signal from the background changes can be corrected. A simple example of this is to obtain an equivalent dose measurement curve at multiple temperatures D_{B}(T,t), where D_{B} is the inferred dose, t is the time, and T is the temperature with no external dose provided. Then D_{T}(φ,t)=D(φ)+D_{B}(T)−D_{B} (T₀). T₀ is the reference temperature, D_{T}(φ, T) is the temperature corrected dose at a flux corrected for background temperature changes, φ is the flux, and D(φ) is the inferred time dependent dose without a temperature correction. The same process can be used to correct for any changes due to relative humidity.

The drawings primarily are for illustrative purposes and is not intended to limit the scope of the subject matter described herein. The drawing is not necessarily to scale; in some instances, various aspects of the subject matter disclosed herein can be shown exaggerated or enlarged in the drawing to facilitate an understanding of different features.

The acts performed as part of a disclosed method(s) can be ordered in any suitable way. Accordingly, embodiments can be constructed in which processes or steps are executed in an order different than illustrated, which can include performing some steps or processes simultaneously, even though shown as sequential acts in illustrative embodiments. Put differently, it is to be understood that such features can not necessarily be limited to a particular order of execution, but rather, any number of threads, processes, services, servers, and/or the like that can execute serially, asynchronously, concurrently, in parallel, simultaneously, synchronously, and/or the like in a manner consistent with the disclosure. As such, some of these features can be mutually contradictory, in that they cannot be simultaneously present in a single embodiment. Similarly, some features are applicable to one aspect of the innovations, and inapplicable to others.

Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing.” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) can be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules can include, for example, a processor, a field programmable gate array (FPGA), and/or an application specific integrated circuit (ASIC). Software modules (executed on hardware) can include instructions stored in a memory that is operably coupled to a processor and can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

What is claimed is:

1. An apparatus, comprising:
a particle source configured to send a first plurality of radiation particles to the thermopile; and
a thermopile configured to measure a location, a spatial characteristic and a radiation rate of the first plurality of particles received from a particle source to produce a measurement value,
the particle source configured to send a second plurality of particles to the thermopile in response to the measurement value.

2. The apparatus of claim 1, wherein the thermopile has a plurality of thermocouples coupled in series and positioned circumferentially about a center location, each thermocouple from the plurality of thermocouples having a length in a radial direction greater than a width in a circumferential direction, each thermocouple from the plurality of thermocouples having a hot junction disposed between the center location and a cold junction of that thermocouple.

3. The apparatus of claim 2, wherein the hot junction for each thermocouple from the plurality of thermocouples has a first radiation attenuation and the cold junction for that each thermocouple from the plurality of thermocouples has a second radiation attenuation, a ratio of the first radiation attenuation and the second radiation attenuation approaching or greater than one hundred.

4. The apparatus of claim 2, wherein the thermopile has a time resolution in the range of about 50 picoseconds to 999 milliseconds.

5. The apparatus of claim 1, further comprising:
a shield disposed about at least a portion of the thermopile and configured to block at least one or incident radiation or scattered radiation from the particle source to affect a differential signal-to-noise ratio in the measurement value.

6. The apparatus of claim 1, further comprising:
a temperature controller coupled to the thermopile and configured to adjust a temperature of an environment of the thermopile to affect a signal-to-noise ratio of the measurement value.

7. The apparatus of claim 1, wherein the thermopile has a plurality of thermocouples, the apparatus further comprising:
a plurality of shields, each shield from the plurality of shields disposed about at least a portion of each thermocouple from the plurality of the thermocouples and configured to block at least a frequency band of radiation emitted from the particle source.

8. The apparatus of claim 1, wherein the thermopile has a plurality of thermocouples coupled in series and positioned about a circumference of a circle having a radius, each thermocouple from the plurality of thermocouples has a hot junction with a first circumference position and a cold junction with a second circumference position without an intervening junction between the hot junction and the cold junction for that thermocouple, the apparatus further comprising:
a first shield having a hollow cylinder geometry with (1) a smooth curved surface including a first radius and (2) a keyed curved surface including an orientation and a second radius less than the first radius; and
a second shield having a hollow cylinder geometry with (1) a smooth curved surface including a first radius and (2) a keyed curved surface including an orientation and a second radius greater than the first radius of the second shield, the orientation of the keyed curved surface of the second shield and the orientation of the keyed curved surface of the first shield configured to block radiation to the cold junctions of each thermocouple from the plurality of thermocouples of the thermopile and to expose radiation to the hot junctions of each thermocouple from the plurality of thermocouples of the thermopile.

9. A method, comprising:
determining a desired integrated radiation dose value to be delivered to a target;
determining a desired error value associated with the desired integrated radiation dose value to be delivered to the target, the desired error value associated with a threshold;
sending, from an ion source and to the target, a first plurality of pulsed radiation;
measuring, using a detector, a temperature value associated with an integrated radiation dose value delivered to the target in response to the plurality of pulsed radiation impacting the target;
calculating an error value between the integrated radiation dose value delivered to the target and the desired integrated radiation dose value; and
sending, from the ion source and to the target, a second plurality of pulsed radiation in response to the error value not satisfying the threshold of the desired error value.

10. The method of claim 9, wherein the detector is a thermopile configured to measure a location, a spatial characteristic and a radiation rate of a plurality of radiation received from a particle source to produce a measurement value, the detector further including:
a temperature controller coupled to the thermopile and configured to adjust a temperature of an environment of the thermopile to affect a signal-to-noise ratio of the measurement value.

11. The method of claim 10, wherein the detector further includes:
a shield disposed about at least a portion of the thermopile and configured to block at least one of background radiation or scattered radiation from the particle source.

12. The method of claim 9, wherein a ratio of the desired error value and the desired integrated dose value is less than a specified amount.
